(19) United States
(12) Patent Application Publication
(10) Pub. No.: US 2026/0203743 A1
(43) Pub. Date: Jul. 16, 2026

(54) PAYMENT CARD MICROCHIP WITH GENERATIVE ARTIFICIAL INTELLIGENCE SYSTEMS AND METHODS

(71) Applicant: MASTERCARD INTERNATIONAL INCORPORATED, Purchase, NY (US)

(72) Inventors: Natesh Babu Arunachalam, Herriman, UT (US); Ahmet Urtan, Mableton, GA (US)

(21) Appl. No.: 19/021,582

(22) Filed: Jan. 15, 2025

(51) Int. Cl. G06Q 20/34; G06Q 20/38; G06Q 20/40

(52) U.S. Cl. CPC G06Q 20/341; G06Q 20/387; G06Q 20/4016

(57) ABSTRACT

An intelligent microchip payment card and/or system therefore for providing secure and personalized payment transactions processed over a payment network using generative artificial intelligence tools. The intelligent payment microchip card includes a memory device for storing a generative artificial intelligence (Gen AI) loyalty and fraud model and a processor in communication with the memory device. The processor is programmed to initiate a payment transaction by communicating with a point-of-sale (POS) terminal, receive payment transaction data associated with the payment transaction, execute the Gen AI loyalty and fraud model by inputting the payment transaction data into the Gen AI loyalty and fraud model, output fraud results from the Gen AI loyalty and fraud model, and authenticate the payment transaction based on the fraud results without additional fraud-related analysis being performed by the payment network processing the payment transaction.

### BACKGROUND OF THE DISCLOSURE

The field of the disclosure relates generally to microchip technology and generative artificial intelligence (Gen AI) tools, and more specifically, to integrating Gen AI tools within a microchip located on a payment card.

These days, payment networks no longer process only payments for banks and retailers, but now process a host of other payment-centric aspects including peer-to-peer transactions, digital identity verification, loyalty programs, and/or security and fraud detection. Existing payment cards may, via a point-of-sale (“POS”) terminal, interface with a network such as a payment network associated with the payment card provider and/or other related entities such as banks of customers and merchants for conducting transactions. Existing payment microchips on payment cards such as credit cards and/or debit cards may contain various software and/or other data stored in a memory of the payment microchip to facilitate transactions. This may include cardholder data such as name and account number, as well as security algorithms and/or payment applications. However, much of the software and/or data present on the payment microchip is static and unable to be updated as fast as customers and/or merchants would like.

A customer using their credit or debit card for a transaction at a merchant may have to wait several seconds for the network to perform certain tasks such as confirming a bank balance and/or running security protocols. Additionally, merchants may desire to capture immediate information from such purchases, for example in connection with the offering of loyalty rewards programs and/or other offers and to gather other business intelligence. Additionally, in today's increasingly internet-connected world, more and more data and computing resources are being shuttled back and forth across cloud connections, and this will only increase over time. Over-reliance on cloud technology presents a significant concern, especially in connection with the advent and implementation of more and more data-heavy systems such as artificial intelligence and/or machine learning systems into various product categories and/or services, and in view of the expectation of instantaneous service by both customers and merchants alike.

Existing payment microchips are not configured to address these issues and/or handle or take advantage of such advances in technology. Merchants expect to understand their customers'behavior in real time, and banks expect fraud and credit decisions to be made with increased accuracy and intelligence all the while such decisions happening faster.

A system and method is needed that addresses the shortcomings of existing systems by: (i) embedding and deploying a generative artificial intelligence (“Gen AI”) model directly onto a payment microchip of a payment card to provide a scalable, efficient, and highly adaptable solution to the evolving threats and opportunities in the payment industry; (ii) providing, via the edge Gen AI model, a dynamic, real-time dual loyalty and fraud functionality system to elevate security measures beyond current industry standards while also providing a tailored loyalty program including personalized loyalty rewards and/or offers based on the customer's specific purchasing patterns; (iii) utilizing and implementing edge computing to reduce response time, add resiliency by creating backup pathways for data to flow through, and operating a Gen AI-based system at the edge of a network without the need for continuous network (e.g., cloud) connectivity; and (iv) using the edge Gen AI model to learn and adapt to the cardholders spending behaviors, enabling it to detect and prevent fraudulent transactions with accuracy that exceeds current systems.

### BRIEF DESCRIPTION OF THE DISCLOSURE

In one embodiment, an intelligent microchip payment card of a cardholder for providing secure and personalized payment transactions processed over a payment network using generative artificial intelligence tools. The intelligent payment microchip card includes at least one memory device for storing a generative artificial intelligence (Gen AI) loyalty and fraud model and at least one processor in communication with the at least one memory device. The at least one processor is programmed to: initiate a payment transaction by communicating with a point-of-sale (POS) terminal of a merchant; receive payment transaction data associated with the payment transaction; execute the Gen AI loyalty and fraud model by inputting the payment transaction data into the Gen AI loyalty and fraud model stored at the at least one memory device of the intelligent payment microchip card; output one or more fraud results from the Gen AI loyalty and fraud model; and authenticate the payment transaction based on the one or more fraud results without additional fraud-related analysis being performed by the payment network processing the payment transaction.

In another embodiment, a computer-implemented method for providing secure and personalized payment transactions processed over a payment network using an intelligent microchip payment card with generative artificial intelligence tools. The method includes: storing on at least one memory of the intelligent microchip payment card a generative artificial intelligence (Gen AI) loyalty and fraud model; initiating, via the intelligent microchip payment card, a payment transaction by communicating with a point-of-sale (POS) terminal of a merchant; receiving payment transaction data associated with the payment transaction at the intelligent microchip payment card; executing the Gen AI loyalty and fraud model by inputting the payment transaction data into the Gen AI loyalty and fraud model; outputting one or more fraud results from the Gen AI loyalty and fraud model; and authenticating the payment transaction based on the one or more fraud results without additional fraud-related analysis being performed by the payment network processing the payment transaction.

In yet another embodiment, one or more non-transitory computer-readable storage media with instructions stored thereon that, in response to being executed, cause an intelligent microchip payment card for providing secure and personalized transactions processed over a payment network using generative artificial intelligence tools to: store, in at least one memory of the intelligent microchip payment card, a generative artificial intelligence (Gen AI) loyalty and fraud model; initiate a payment transaction by communicating with a point-of-sale (POS) terminal of a merchant; receive payment transaction data associated with the payment transaction; execute the Gen AI loyalty and fraud model by inputting the payment transaction data into the Gen AI loyalty and fraud model stored at the at least one memory of the intelligent microchip payment card; output one or more fraud results from the Gen AI loyalty and fraud model; and authenticate the payment transaction based on the one or more fraud results without additional fraud-related analysis being performed by the payment network processing the payment transaction.

In yet another embodiment, a computer-based payment system for providing secure and personalized transactions processed over a payment network using generative artificial intelligence tools. The computer-based payment system includes an intelligent microchip payment card associated with a cardholder, the intelligent microchip payment card including a microchip and memory storing a generative artificial intelligence (Gen AI) loyalty and fraud model and a point-of-sale (POS) terminal configured to interface with the intelligent microchip payment card. The POS terminal includes: at least one POS terminal memory device for storing POS terminal data; and at least one POS terminal processor in communication with the at least one POS terminal memory device. The at least one POS terminal processor is programmed to initiate a payment transaction by communicating with the intelligent microchip payment card and providing payment transaction data to the microchip. The microchip is configured to: receive the payment transaction data; execute the Gen AI loyalty and fraud model by inputting the payment transaction data into the Gen AI loyalty and fraud model stored at the memory of the intelligent microchip payment card; output one or more fraud results from the Gen AI loyalty and fraud model; and authenticate the payment transaction based on the one or more fraud results without additional fraud-related analysis being performed by the payment network processing the payment transaction.

### BRIEF DESCRIPTION OF THE DRAWINGS

FIGS. 1-10 illustrate exemplary embodiments of the systems and methods described herein.

FIG. 1 is a schematic diagram illustrating an example multi-party payment processing system for enabling payment transactions used in conjunction with a computer-based payment system that includes a Gen AI loyalty and fraud (“GALF”) computing system, in accordance with one embodiment of the present disclosure.

FIG. 2 is a block diagram illustrating an example subsystem of the computer-based payment system shown in FIG. 1, according to one embodiment of the present disclosure.

FIG. 3 is a schematic diagram illustrating an example process flow diagram for the computer-based payment system shown in FIG. 1, according to one embodiment of the present disclosure.

FIG. 4 is a diagram illustrating an example embodiment of components of the computer-based payment system shown in FIG. 1, according to one embodiment of the present disclosure.

FIG. 5A is a diagram illustrating an example embodiment of a configuration of components of the computer-based payment system shown in FIG. 1, according to one embodiment of the present disclosure.

FIG. 5B is a block diagram illustrating an example embodiment of a transaction processing flow according to one embodiment of the present disclosure.

FIG. 6 is a process flow diagram illustrating an artificial intelligence/machine learning module diagram associated with the GALF computing system shown in FIG. 1, according to one embodiment of the present disclosure.

FIG. 7A illustrates an example method for providing and implementing the GALF model according to one embodiment of the present disclosure.

FIG. 7B illustrates an example method for applying an output of the GALF model to a transaction according to one embodiment of the present disclosure.

FIG. 8 is a block diagram illustrating an example configuration of a computing system according to one embodiment of the present disclosure.

FIG. 9 is a block diagram illustrating an example configuration of a server and/or client computing device according to one embodiment of the present disclosure.

FIG. 10 is a block diagram illustrating an example configuration of a user computing device associated with the computer-based payment system according to one embodiment of the present disclosure.

Like numbers in the Figures may indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The following detailed description illustrates embodiments of the present disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing Gen AI on a payment microchip of a payment card, and enhanced loyalty program and security (e.g., fraud) systems and measures.

By embedding a Gen AI model directly onto a payment microchip of a payment card and deploying the Gen AI model therefrom, a dynamic, real-time security and loyalty system (including merchant funded rewards) that operates at the edge of a network is able to be realized and implemented, without the need for continuous network (e.g., cloud) connectivity. Such a Gen AI model included with an edge computer system is designed to learn and adapt to the cardholder's spending behaviors, enabling it to detect and prevent fraudulent transactions with unprecedented accuracy. Furthermore, the generative AI aspects of this technology personalize loyalty reward earnings and other loyalty-based offers based on the user's specific purchasing patterns, thereby enhancing customer satisfaction and engagement. This dual functionality not only elevates the security measure beyond the current industry standards but also introduces a tailored loyalty program, setting a new benchmark for card issuer services. The deployment of Gen AI models on payment microchips represents a significant advancement in the field of secure and personalized financial transactions, offering a scalable, efficient and highly adaptable solution to the evolving threats and opportunities in the payment industry.

The Gen AI loyalty (“GAL”) model may be based and trained on information/data including but not limited to: (a) user purchase history; (b) merchant name involved in the transaction; (c) location of the transaction or merchant; and (d) time of the transaction. The Gen AI fraud (“GAF”) model may be based on and trained on information/data including but not limited to: (a) user purchase history; (b) location of the merchant or user; (c) time of the transaction; (d) transaction value; and (e) merchant risk. The GAL and GAF models may be referred to individually, or the GAL and GAF models may collectively be referred to as a “GALF” model.

Another aspect of the present disclosure is a robust edge-computing infrastructure capable of addressing the increasingly complex business of detecting and preventing fraud, and implementing fraud systems and methods via the Gen AI on the payment microchip as described herein. The “center” of a network may include the components where most of the routing, switching, and/or data processing occurs. This may include central servers, data centers, and main network infrastructure. The “edge” of a network may be a point in the network at which data enters or exits the network, such as in an outer layer of the network. This may include devices such as routers, switches, and gateways connecting to end-user devices.

As described herein, edge computing is where more data flow and computations happen at the so-called “edges” of a network instead of just in the center of the network. It may be configured and deployed to counteract issues associated with centralized cloud computing. Edge computing includes running fewer processes in the cloud and moving those processes local, for example to a user's computer and/or an edge server, and the like. Such edge computing techniques may include but are not limited to multiple hybrid connectivity models, in which a blend of cloud and edge computing technologies may be utilized. This is in contrast to prior techniques relying only on an appliance installed in datacenters of entities within the payment network. With increased adoption and the evolution of digital payment services, including mobile e-commerce, account-to-account payments, and open banking, such edge computing techniques as described herein may utilize application programming interfaces (“APIs”) to provide new connections between platforms and within networks.

Edge technology complements cloud technology by situating logic, compute resources, and data storage closer to the devices where the data is being gathered, reducing latency issues, and improving an application's ability to provide data in real time. Rather than rely on a central location that can be hosted thousands of miles away, edge computing supports applications that run on smartphones and other mobile devices such as smart watches. The edge computing techniques described herein build an event-driven framework that pushes more compute workloads to the edge, and may include decisioning intelligence to help make decisions at the edge without requiring connections to central sites. Additionally, the fraud techniques described herein may be configured to utilize and implement a hub framework in which hubs are distributed globally and may run independently, all the while utilizing data across domains or through other sources.

The edge computing techniques described herein allow for centralized security solutions traditionally utilized via a distributed module to be pushed and deployed to edge platforms, ensuring high-speed, low-latency, and high-throughput network interfaces, and may even include edge-based authorization and authentication.

The payment microchip may include memory and an operating system such as a card operating system (“COS”), which may be configured as a micro-operating system. The payment microchip itself may be configured to be powered by (i) physical contact with a power source, and/or (ii) wireless power techniques including but not limited to inductive coupling. The payment microchip may have a plurality of pins or contacts/contact pads with designated functions. Such pins or contacts/contact pads may include but are not limited to voltage/power and data contacts, which may include dedicated contacts for circuit aspects such as V_{cc}, RST, CLK, RFU, GND, V_{PP}, I/O, and RFU.

When the payment microchip is powered, it activates and exchanges data for the transaction. Activation applies power to the V_{cc} pin or V_{cc} contact pad at a designated voltage, such as a voltage determined by a standard and/or other specification, and the clock associated with the CLK pin or CLK contact pad starts. The clock may be configured to run in the MHz clock speed range (e.g., between 1 Mhz and 5 Mhz). The payment microchip may be configured with software such as application software that may include, for example, an application protocol data unit (APDU) to send data. In some embodiments, the payment microchip is configured with a power management circuit that regulates the power received from the POS terminal, ensuring that it operates within the required voltage and current levels.

In tap-to-pay configurations, when a payment microchip is tapped against a designated surface of the POS terminal that corresponds to a location of an internal power coil of the POS terminal, the POS terminal generates a small electromagnetic field through inductive coupling via the power coils inside the POS terminal. This field induces a current in an internal power coil of the payment microchip, providing the necessary power for the payment microchip to operate. During this inductive-based powered state, the Gen AI model on the payment microchip, as described herein, may be deployed and/or updated. In some embodiments, a payment microchip configured for contactless transactions may communicate with the POS terminal using Radio Frequency (RF) communication at a designated frequency, such as at 13.56 MHz. The POS terminal may emit a designated RF signal, and the payment microchip may respond by sending back the necessary data for the transaction.

When a payment microchip is inserted into a POS terminal, corresponding contacts inside the POS terminal physically contact the contact pads of the payment microchip, thereby providing power and/or data connectivity pathways between corresponding POS terminal contacts and contact pads of the payment microchip. During this contact-based powered state, the Gen AI model on the payment microchip may be deployed and/or updated.

In some embodiments, the payment microchip is configured to use security standards including but not limited to Advanced Encryption Standard (AES) and Triple Data Encryption Standard (3DES) algorithms to encrypt the data before transmitting it to the POS terminal, ensuring that cardholder information is protected from unauthorized access.

Offline data authentication (ODA) may be utilized and may include performing a cryptographic check to validate the payment card using cryptography such as public-key cryptography. This may, depending on the payment card, include: (a) static data authentication (SDA) which is configured to ensure data read from the payment card has been signed by the payment card issuer, for example to prevent modification of data; (b) dynamic data authentication (DDA), configured to provide protection against modification of data and/or cloning; and (c) combined DDA/generate application cryptogram (CDA), which may combine DDA with the generation of an application cryptogram of the payment card to ensure that the payment card is valid. Offline authentication methods may be configured to use data from the payment card to allow the POS terminal to authenticate the payment card. The POS terminal may be preloaded with keys. During a transaction, a check may be performed to check complementary keys on the payment card for each transaction.

In some embodiments, the payment microchip may be configured to include a secure element that stores various data including but not limited to cardholder data. The secure element may also be configured to perform cryptographic operations. The secure element is configured to ensure that sensitive data is encrypted and securely transmitted during the transaction. The cryptographic operations may be built on private key infrastructure, meaning only a personalized chip card with the cardholder's private key during manufacturing can generate a valid transaction.

In the example embodiment, the payment card microchip is an EMV chip. Embedding an AI model such as a Gen AI on an EMV chip enables real-time decisioning for card payments. This feature may be implemented as a value added service that enhances transaction revenue. Merchants may improve their sales by offering real time decisioning. Customers may increase cart value when relevant personalized rewards are offered to them using the AI model.

The EMV chip may be configured to be compliant with industry standards including but not limited to: (1) ISO/IEC 7816: Identification Cards (e.g., Integrated Circuit(s) Cards); (2) ISO/IEC 14443: Identification Cards (e.g., Contactless Integrated Circuit(s), Cards-Proximity Cards; and/or ISO 8583 (e.g., financial transaction card originated messages). In addition to payment cards, EMV chips may also be configured to support payments made with mobile devices (such as smartphones, watches, wristbands, etc.) that use Near Field Communications (NFC) technology to act as contactless chip cards and for payment tokenization. Payment tokenization offers enhanced security for chip payments made with mobile devices, such as mobile wallets, by replacing valuable card data in a transaction with a payment token, which is worthless if stolen.

For example, ISO/IEC 7816-3 may be utilized to define processes for application selection and/or the transmission protocol between chip cards and readers. Using this protocol, data is exchanged in APDUs. This may include sending a command to a payment card, the payment card processing it, and sending a response. The payment chip may use the following commands: (a) application block; (b) application unblock; (c) card block; (d) external authenticate (e.g., 7816-4); I generate application cryptogram; (f) get data (e.g., 7816-4); (g) get processing options; (h) internal authenticate (e.g., 7816-4); (i) PIN change / unblock; (j) read record (e.g., 7816-4); (k) select (e.g., 7816-4); and (1) verify (e.g., 7816-4).

More generally, a transaction initiated using a payment microchip-based payment card may include the following stages: (a) application selection; (b) initiate application processing; (c) read application data; (d) processing restrictions; (e) offline data authentication; (f) certificates; (g) cardholder verification; (h) terminal risk management; (i) terminal action analysis; (j) first card action analysis; (k) online transaction authorization (only carried out if required by the result of the previous steps; mandatory in ATMs); (1) second card action analysis; and (m) issuer script processing.

The payment microchip may be configured to include an application file locator (AFL), which may include a list of files and records that the POS terminal needs to read from the payment microchip. Reading application data may include reading files in the AFL that contain payment microchip data. One or more data elements may be read in the application processing staged and reviewed for compliance, where such data elements may include: (1) reviewing the application version number; (2) reviewing application usage control (e.g., which may define if the payment card is only for domestic use, etc.); and (3) reviewing application effective/expiration dates. If any of these reviews fail, the payment card may (or may not) be declined depending on card verification parameters set by the corresponding entity. That being said, in some configurations, a card that only fails to be verified for a valid expiration date may not trigger a decline. The POS terminal may be configured to set appropriate settings as part of terminal verification results of the POS terminal. These settings may form the rules and/or other parameters that define the basis of an accept/decline decision.

Certificates may be utilized to verify the authenticity of payment cards. In some embodiments, a certificate authority such as the EMV Certificate Authority may issue digital certificates to payment card issuers. When requested, the payment microchip provides a public key certificate and other information of the payment card issuer to the POS terminal. The POS terminal may be configured to retrieve a public key of the certificate authority for confirmation/verification that the public key was signed by the certificate authority. The public key may be stored in an on-board memory of the POS terminal. If the public key of card issuer is determined to be valid, the POS terminal may use the public key to verify that payment card was signed by/issued by the payment card issuer.

Cardholder verification may include conducting and evaluation of whether the person presenting the payment card is the legitimate cardholder. One or more of a plurality of cardholder verification methods may be utilized in this stage, including signature, a personal identification number (“PIN”), or signature and PIN. Point-to-point encryption may be utilized and implemented. Biometric verification methods may also be utilized and implemented to add further protections.

Machine learning (ML) is a subset within the more general artificial intelligence (AI) field. AI/ML techniques and/or models may be used in conjunction with the GALF system and methods described herein. ML involves the development and study of statistical algorithms that can be used to effectively perform tasks without explicit instructions on how to do it. For example, a machine learning model may be trained using historical data that enables the model to recognize patterns within the data and outputs resulting from those patterns. Thus, when the model is trained and applied to new data that is inputted into the model, the model is able to recognize those same patterns and predict an output based on the outputs from the historical data. Of course, in order to build and train the models that are subsequently used in the machine learning tools, it is beneficial to have quality data that is properly labeled and accurately represents the information that is desired to be learned about (although unlabeled data may also be used). The use of quality data having accurate labeling helps to ensure that the models that are trained and built will be able to accurately predict outcomes when applied to new data. ML has been applied and used in many areas and industry segments, including but not limited to large language models (LLMs), computer vision, speech recognition, email filtering, agriculture, medicine, insurance, and the financial or payment industry. In the payment industry, and as described herein, ML may be used in connection with determining patterns and/or gleaning other pertinent information relating to transactions, including the determining of spend and fraud patterns, etc.

As described herein, existing payment cards and payment systems have various drawbacks and problems, including their utilization of largely static information that is not dynamic and is unable to be updated in a timely manner, and/or does not have the ability to capture transaction data and/or aspects thereof in a manner that is expected by today's merchants and/or banks in the payment industry. Payment networks need to be able to quickly and accurately capture and process data for merchant transactions, peer-to-peer transactions, digital identity verification, loyalty programs, and/or security and fraud detection. Over-reliance on centralized cloud infrastructure may impede the ability to quickly and efficiently collect and analyze the vast amounts of data relating to and/or resulting from such variety of transaction types and make intelligent decisions regarding such data.

A system and method is needed that addresses the shortcomings of existing systems by: (a) embedding and deploying a generative artificial intelligence (“Gen AI”) model directly onto a payment card microchip to provide a scalable, efficient, and highly adaptable solution to the evolving threats and opportunities in the payment industry; (b) providing, via the edge Gen AI model, a dynamic, real-time dual loyalty and fraud functionality system to elevate security measures beyond current industry standards while also providing a tailored loyalty program including personalized loyalty rewards and/or offers based on the customer's specific purchasing patterns; (c) utilizing and implementing edge computing to reduce response time, add resiliency by creating backup pathways for data to flow through, and operate a Gen AI-based system at the edge of a network without the need for continuous network (e.g., cloud) connectivity; and (d) using the edge Gen AI model to learn and adapt to the cardholders spending behaviors, enabling it to detect and prevent fraudulent transactions with accuracy that exceeds current systems.

At least one technical effect of the systems and methods described herein is achieved by performing at least one of the following steps and/or causing at least one of the following results: (a) increased speed and accuracy in processing transactions; (b) increased speed and accuracy in presenting personalized incentives and/or offers such as retail/merchant offers to customers; (c) improving security via advanced security and/or fraud protocols; (d) increased personalization of offers and/or other incentives to loyalty program members; (e) improved efficiency and effectiveness in handling vast amounts of data using a variety of aspects of network infrastructure, including edge computing; (f) improvements in edge computing techniques; (g) implementing AI/ML and/or rules-based intelligence to determine financial patterns of customers, including customer spending, loyalty rewards programs, and/or fraud patterns; (h) improvements in systems capable processing and providing dynamic information and making on-the-fly adjustments; (i) improvement of processing speed and bandwidth by enabling Gen AI models to leverage spending behavior for transactions without running all transactions, and enabling Gen AI fraud models to generate accurate fraud determinations in real-time without having to rebuild those fraud models; and (j) reducing the amount of messages needed within a payment network in order to approve a transaction as being acceptable (e.g., non-fraudulent and/or within a certain risk threshold). More generally, a technical effect of the systems and methods described herein is improvements in payment card technology and/or payment technology systems. The methods and systems described herein may be implemented using computer programming or engineering techniques including computer software, firmware, hardware or any combination or subset thereof.

By implementing the Gen AI systems and methods described in the present disclosure, enhancements to security and convenience for users can be realized. Entities that utilize such systems and methods may strengthen their position in the competitive digital banking landscape by delivering innovative and value-added services to its customers. In this regard, additional benefits of the payment card Gen AI systems and methods described herein include but are not limited to: (a) improved customer and merchant engagement; (b) improved convenience in conducting and analyzing transactions; (c) comprehensive transaction history; (d) improvements in handling/providing dynamic data; and (e) improved control over loyalty rewards programs and customer incentives.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, “machine learning” (also referred to as ML) refers to statistical techniques to give computer systems the ability to “learn” (e.g., progressively improve performance on a specific task) with data, without being explicitly programmed for that specific task. The terms “neural network” (NN) and “artificial neural network” (ANN), used interchangeably herein, refer to a type of machine learning in which a network of nodes and edges is constructed that can be used to predict a set of outputs given a set of inputs.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

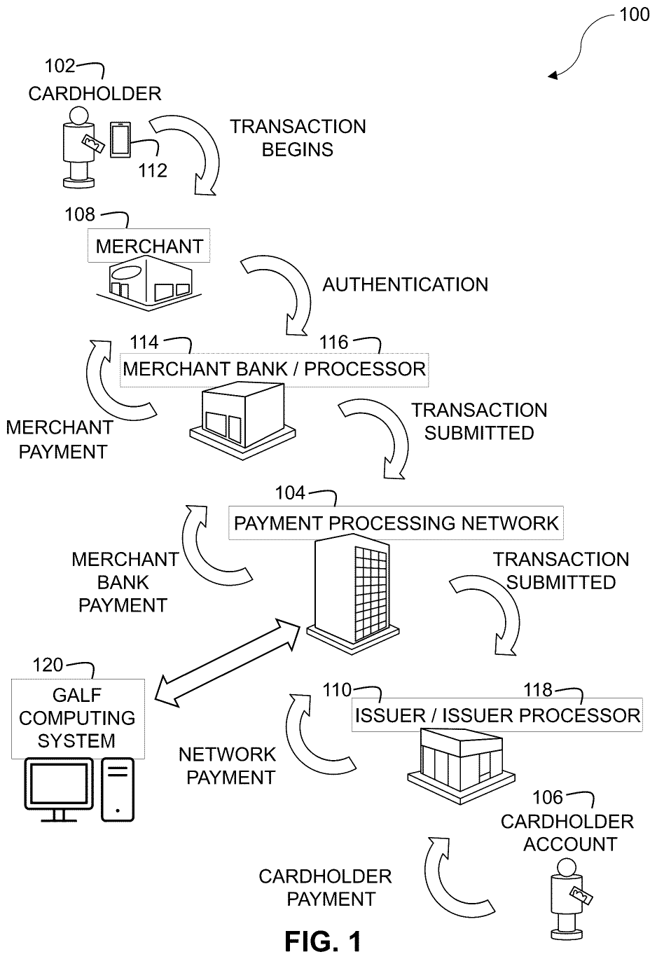

FIG. 1 illustrates a schematic diagram of an example multi-party payment account system 100 for enabling payment transactions initiated by cardholders 102 (e.g., also referred to as users, customers, and/or purchasers) over a payment processing network 104 that is in communication and used in conjunction with a Gen AI Loyalty and Fraud “GALF” computing system 120, as described below in more detail. Cardholders 102 have associated cardholder accounts 106. The GALF computing system 120 is configured to collect data from a merchant 108 (e.g., transaction data, operations data) and/or an issuer bank 110 (e.g., also referred to herein as issuer 110) in association with transactions made by a user. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, the GALF computing system 120 is communicatively coupled to merchant 108, payment processing network 104, and issuer 110 (e.g., issuer bank). As used herein, merchant 108 and issuer 110 may be directly coupled to the GALF computing system, or may be indirectly coupled to GALF computing system 120 through payment processing network 104.

In the example embodiment, a financial institution called the “issuer” or “issuing bank” issues an account, such as a primary savings/checking account, credit card account, a debit account, or a prepaid card account to a cardholder 102, who uses the account to tender payment for a purchase from a merchant 108. In one embodiment, cardholder 102 presents a payment card to merchant 108 using a user computing device (also known as card-present transactions). In another embodiment, the user does not present a physical payment device such as a payment card, and instead performs a card-not-present transaction. For example, the card-not-present transaction may be initiated via a digital wallet application, through a website or web portal, via telephone, or any other method that does not require the user to present a physical payment card to merchant 108 (e.g., via swiping, tapping, or inserting the payment card). In some embodiments, using a digital wallet in-store via scanning of a symbol or code associated with the digital wallet and/or using a tap-to-pay feature of a mobile phone that is linked to a digital wallet may be considered a card-present transaction.

To accept payment with the transaction card, merchant 108 establishes an account with a financial institution that is part of the financial payment system. This financial institution is usually called the “merchant bank,” the “acquiring bank,” or the “acquirer.” In one embodiment, cardholder 102 tenders payment for a purchase using a transaction card at a transaction processing device 112 (e.g., transaction device 112, e.g., a point of sale device in an in-store context, or a mobile computing device (e.g., mobile phone) or desktop/laptop computer in an at-home (e.g., online shopping) context), then merchant 108 requests authorization from a merchant bank 114 for the amount of the purchase. The request is usually performed through the use of a point-of-sale terminal (“POS terminal”) or a computing device or computer app, which reads account information of cardholder 102 from a magnetic stripe, a microchip, barcode, or embossed characters on the transaction card (e.g., a debit card or a prepaid card) or otherwise imputed by the cardholder and communicates electronically with the transaction processing computers of a merchant bank 114. Alternatively, merchant bank 114 may authorize a third party to perform transaction processing on its behalf. In this case, the point-of-sale terminal will be configured to communicate with the third party. Such a third party 116 is usually called a “merchant processor,” an “acquiring processor,” or a “third party processor.”

In the example embodiment, merchant 108 communicates with, either directly or indirectly via processing network 104, other systems within multi-party payment account system 100 to authenticate cardholder 102 before the transaction is further processed or to assist an authentication device that is part of the multi-party payment account system shown in FIG. 1 in authenticating cardholder 102. For example, the same entity that provides the GALF computing system may provide systems that can authenticate cardholder 102 as described herein. Once cardholder 102 has been authenticated, using processing network 104, computers of merchant bank 114 or merchant processor 116 (e.g., acquiring processor 116) will communicate with computers of an issuer bank 110 to determine whether an account 106 of cardholder 102 is in good standing and whether the purchase is covered by available funds and/or an available credit line of cardholder 102. Based on these determinations, the request for authorization will be declined or accepted. If the request is accepted, an authorization code (e.g., included in an authorization message) is issued to merchant 108. An authorization message includes a transaction identifier associated with the transaction and an indicator indicating that the transaction was authorized. If the request is not accepted, authorization message includes a transaction identifier associated with the transaction and an indicator indicating that the transaction was declined. In the example embodiment, an authorization message is formatted according to ISO 8583 network messaging protocol or the equivalent messaging protocol used by the payment card processing network.

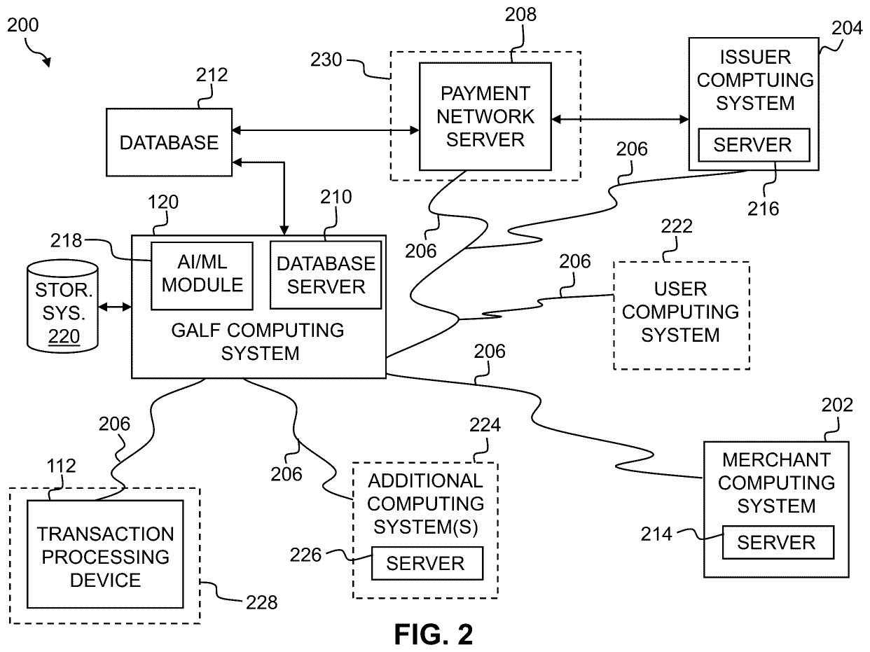

When a request for authorization is accepted, the available funds and/or other credit line of account 106 of cardholder 102 is decreased. Normally, a charge for a payment card transaction is not posted immediately to account 106 of cardholder 102 because certain rules do not allow merchant 108 to charge, or “capture,” a transaction until goods are shipped or services are delivered. However, with respect to at least some payment (e.g., debit) card transactions, a charge may be posted at the time of the transaction. When merchant 108 ships or delivers the goods or services, merchant 108 captures the transaction by, for example, appropriate data entry procedures on the point-of-sale terminal. This may include bundling of approved transactions daily for standard retail purchases. If cardholder 102 cancels a transaction before it is captured, a “void” is generated. If cardholder 102 returns goods after the transaction has been captured, a “credit” is generated. Processing network 104 and/or issuer bank 110 stores the transaction information, such as a type of merchant, amount of purchase, date of purchase, etc. in a database (e.g., database 212, shown in FIG. 2).

After a purchase has been made, a clearing process occurs to transfer additional transaction data related to the purchase among the parties to the transaction, such as merchant bank 114, processing network 104, and issuer bank 110. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 108, merchant bank 114, and issuer bank 110. Settlement refers to the transfer of financial data or funds among account of merchant 108, merchant bank 114, and issuer bank 110 related to the transaction. Usually, transactions are captured and accumulated into a “batch,” which is settled as a group. More specifically, a transaction is typically settled between issuer bank 110 and processing network 104, and then between processing network 104 and merchant bank 114, and then between merchant bank 114 and merchant 108.

As described above, the various parties to the payment card transaction include one or more of the parties shown in FIG. 1 such as, for example, cardholder 102, merchant 108, merchant bank 114, processing network 104 (also referred to herein as an interchange or an interchange network), issuer bank 110, and/or an issuer processor 118. A transaction may be referred to in a temporal manner, such a historical (e.g., past or prior) transactions, current, or live (e.g., a transaction that may be occurring at any given live moment).

GALF computing system 120 may be in operative communication with merchant 108, merchant bank 114, merchant processor 116, and issuer 110 and issuer processor 118 via payment network 104, and/or directly with respect to each such entity.

FIG. 2 illustrates a schematic diagram of an example computer-based payment subsystem 200 including GALF computing system 120 and a plurality of client sub-systems and/or other computing systems coupled to GALF computing system 120, usable within or in communication with multi-party payment account system 100 as shown in FIG. 1. Client sub-systems may include merchant computing system 202 of merchant 108 (also referred to as merchant computing device 202, or more generally client sub-system 202) and issuer computing system 204 of issuer 110 (also referred to as issuer computing device 204, or more generally client sub-system 204).

Client sub-systems 202 and 204 are coupled to the Internet through many interfaces including a network 206, such as a local area network (LAN) or a wide area network (WAN), dial-in-connections, cable modems, special high-speed Integrated Services Digital Network (ISDN) lines, and RDT networks. Merchant system 202 includes systems associated with merchants 108 (shown in FIG. 1) as well as external systems used to store data. For example, merchant computing system 202 may include transaction processing device 112 (shown in FIG. 1), which may be realized as a point-of-sale (POS) computing device (also referred to as POS terminal) communicatively and operatively coupled to an external system of merchants 108, or a website used by the merchant to sell goods or services. Transaction processing device 112 may alternatively be configured as a card reader that is configured to connect to mobile device such as a smart phone and/or tablet for accepting payments via the card reader. The card reader may be physically connected to port (e.g., USB-C, headphone jack) of the mobile device and utilize a network connection of the mobile device to interface with the payment network. Such a card reader may allow for a payment card to be swiped, inserted, or tapped. Yet further, the card reader may not need to have such a dongle-type connection to a mobile device, and may be a standalone device capable of accepting payments. Issuer computing system 204 includes systems associated with issuer banks 110 (shown in FIG. 1) as well as external systems used to store data. GALF computing system 120 is also in communication with a payment network server 208 associated with processing network 104 (shown in FIG. 1) using network 206. Further, client sub-systems 202 and 204 may additionally communicate with processing network 104 using network 206. In more general terms, client sub-systems 202 and 204 could be any device capable of interconnecting to the Internet including a web-based (e.g., mobile) phone, PDA, smart devices, or any other web-based connectable equipment such as a POS terminal (e.g., an embodiment of transaction processing device 112 (shown in FIG. 1)).

A database server 210 of GALF computing system 120 is coupled to a database 212, which contains information and data on a variety of matters. For example, database 212 may store cardholder transaction data and issuer/merchant rules regarding transactions. Cardholder transaction data may be processed, sorted, and/or otherwise analyzed according to a list of defined parameters (e.g., transaction type, transaction time, device on which the transaction was initiated, dollar amount of transaction, market segment of merchant and/or item purchased, payment network parameters, and/or any other applicable parameter relating to ways to categorize such transactions) and rules. In one embodiment, database 212 is a centralized database stored on GALF computing system 120, where access to centralized database 212 may be controlled by rules defined within subsystem 200 to limit the display of data to authorized client users enrolled with subsystem 200. In an alternative embodiment, database 212 is stored remotely from GALF computing system 120 and may be non-centralized. Database 212 may be a database configured to store information used by GALF computing system 120 including, for example, historical and current transaction data, prompt data, other user data, merchant data, issuer data, and/or other applicable data. Database 212 may include a single database having separated sections or partitions, or may include multiple databases, each being separate from each other. In some embodiments, database 212 stores transaction data generated over the processing network including data relating to merchants, consumers, cardholders, prospective customers, issuers, acquirers, and/or purchases made. Database 212 may include multiple storage units such as hard disks or solid state disks in a redundant array of inexpensive disks (RAID) configuration, and may include a storage area network (SAN) and/or a network attached storage (NAS) system. In some embodiments, database 212 may be localized near a geographic area of the transaction to reduce lag, latency, and/or other delay. For example, database 212 may be utilized in conjunction with an edge computing arrangement.

Additional systems and components within subsystem 200 may include a server 214 of merchant system computing 202, a server 216 of issuer computing system 204, an artificial intelligence/machine learning (AI/ML) module 218 of GALF computing system 120 (described in more detail herein), a storage system 220, a user computing system 222 (also referred to as a user computing device 222), and an optional additional computing system 224, including a server 226. System 224 may be referred to as a client sub-system in a manner the same as or similar to systems 202 and 204, and may be a system of a related entity such as a real-time payment provider and/or a digital wallet provider whose services may be able to be utilized and implemented in conjunction with tap-to-pay payments made via a mobile phone. For example, GALF computing system 120 may be configured to utilize such tap-to-pay mobile phone payments in a manner that is the same as or similar to such tap-to-pay payments made with a physical payment card. System 224 may additionally, or alternatively, be a distributed computing system configured to provide distributed computing resources, for example to assist with data-heavy processing associated with the Gen AI model.

Server 214 may be configured to provide access to resources, data, services, and/or programs to other computers of merchants 108 over network 206. Server 216 may be configured to provide access to resources, data, services, and/or programs to other computers of issuers 110 over network 206. AI/ML module 218 may be configured to assist with providing insight into transactions including spend and fraud aspects of transactions as performed by GALF computing system 120, by learning transaction and calculation patterns over time via one or more models. Storage system 220 may include one or more storage devices used in conjunction with GALF computing system 120, and may store therein both historical (e.g., training) data for training a model of AI/ML module 218, as well as newer transaction data and other data and information used to update intelligence-based rules and/or algorithms of AI/ML module 218, for use in association with the analysis performed by GALF computing system 120. User computing system 222 (also referred to as a user computing device 222) may include a personal computing device such as a smartphone, tablet, personal computer (desktop or laptop), and the like, and may be configured and implemented as transaction processing device 112 in certain scenarios (such as when using a personal mobile device to pay instead of a physical card). Third party computing system 224 may include a system of a third party that provides, for example, real-time payment and/or digital wallet services as described herein. Server 226 of third party computing system 224 may be configured to provide access to resources, data, services, and/or programs to other computers of a third party entity over network 206.

In one embodiment, storage system 220 may be integrated with GALF computing system 120. In other embodiments, storage system 220 may be integrated with database 212, or any other storage or database within subsystem 200. The model of AI/ML module 218 may be trained on transaction and/or other user data to be able to better recognize and categorize new transactions, determine fraudulent transactions, and/or assist with other related calculations and other procedures including in connection with loyalty programs. While AI/ML module 218 is shown in FIG. 2 as being integrated within GALF computing system 120, it may also be separate from (but still operatively coupled to) GALF computing system 120.

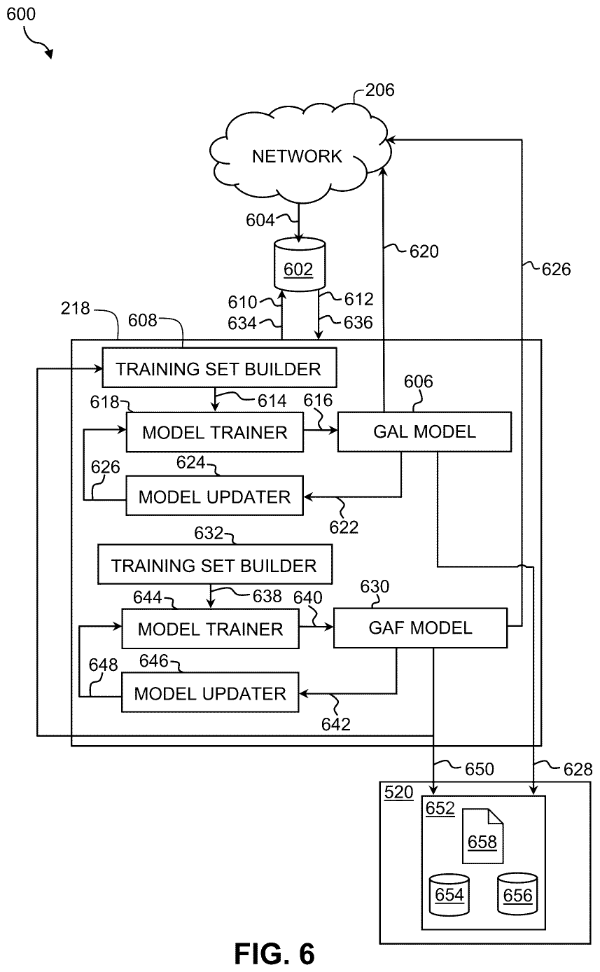

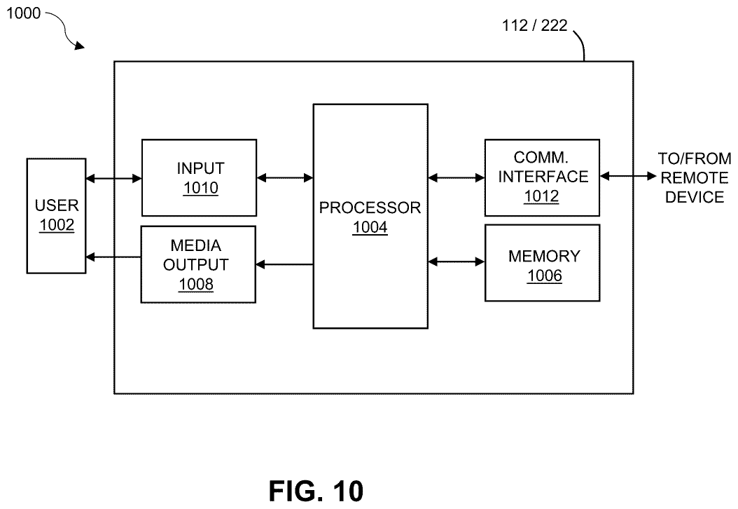

In some embodiments, user computing device 222 may be a computing device belonging to a provider of the GALF computing system 120, and used in conjunction with GALF computing system 120 within subsystem 200. In such a case, a user (e.g., user 1002, shown in FIG. 10) may review outputs from GALF computing system 120, which may include outputs (e.g., 628 and 650 from AI/ML module 218, as shown in FIG. 6). User computing device 222 may include a server (not shown) configured to provide access to resources, data, services, and/or programs to other computers. For example, a user (e.g., such as user 1002) may be an employee of the entity that provides, owns, and/or operates GALF computing system 120. In this regard, outputs 628 and 650 shown in FIG. 6 may output results from calculations and other processes performed by GALF computing system 120 in a user-readable format for presentation to the user 1002, so that the user 1002 may analyze the results (e.g., for purposes of verifying the accuracy of the spend and/or fraud predictions and/or models from model modules 606 and 630, such as for updating the models, etc.). In some embodiments, transaction processing device 112 may be at an edge 228 of the network, as compared, for example, to a device such as payment network server 208, which may be located at a center 230 of the network. Edge and cloud computing techniques may be used in combination to achieve a best of both worlds operating environment. By utilizing edge computing aspects, fraud and loyalty determinations can be made at the card level, reducing the amount of messages needed to approve a transaction for fraud purpose and/or determine loyalty/rewards earnings, offers, etc.

As described in more detail herein, the machine learning models may utilize user patterns to detect spending and/or anomalous activity in real-time, for example for use in transaction analysis and fraud detection. A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs. Additionally or alternatively, the machine learning programs may be trained by inputting sample data sets or certain data into the programs, such as transaction data, network messages (e.g., ISO 8583 messages), and/or other internal data regarding transactions. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination, for use, for example, in generating outputs for human consumption. The machine learning programs may also include natural language processing, semantic analysis, automatic reasoning, and/or (supervised) machine learning. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

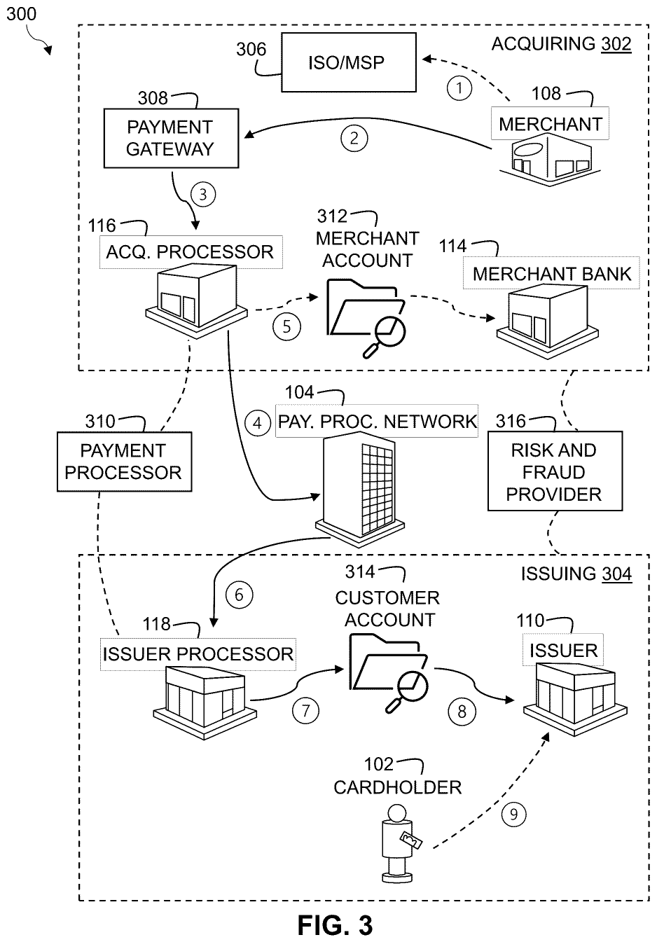

FIG. 3 illustrates an example process flow 300 for transactions within subsystem 200 and using the various computing components shown in FIG. 2, in accordance with one embodiment of the present disclosure. Process flow 300 includes an acquiring stage 302 and an issuing stage 304. Numbered arrows/pathways 1 through 9 represent one embodiment of an order of a transaction being processed.

Acquiring stage 302 illustrates the flow of transaction data of a transaction between related entities such as the various acquiring entities as shown in FIG. 1. Transaction data of a transaction at merchant 108 may be communicated via arrow 1 to an ISO/MSP entity 306 (e.g., where ISO stands for an independent sales organization and MSP stands for merchant services provider(s)). ISOs/MSPs such as ISO/MSP 306 may be third-party companies that have partnerships with card association member banks and provide merchants with payment processing services on their behalf.

Transaction data of the transaction at merchant 108 may also be communicated via arrow 2 to a payment gateway 308 provided by a payment gateway provider entity. A payment gateway such a payment gateway 308 may include a technology or service that securely transmits payment information between the customer, the business, and the payment processor. Payment gateway 308 may be configured as a bridge between the parties involved in a transaction, enabling the exchange of information required for processing payments. Payment gateway 308 may in some aspects be treated as a digital equivalent of a POS terminal such as transaction processing device 112 that is present at physical merchant retail stores. Payment gateway 308 ensures that sensitive payment information is handled securely, as payment gateways adhere to strict security standards and encryption protocols such as the Payment Card Industry Data Security Standard (“PCI DSS”). Payment gateway 308 may streamline integration between merchant 108, and may provide APIs, plugins, and/or other modules to merchant 108 so that merchant 108 is able to accept payments, including online payments.

Payment gateway 308 may transmit transaction data via arrow 3 to acquiring processor 116. Acquiring processor 116 may transmit transaction data to a payment processor 310, and, via arrow 4, to payment processing network 104. Payment processor 310 may be a company or service that facilitates electronic transactions between customers and businesses by processing and authorizing credit card, debit card, and other digital payment methods. Payment processors such as payment processor 310 may verify the customer's payment details, check for fraud, ensure compliance with applicable regulations, and/or authorize or decline the transaction.

Payment gateway 308 may be a connective component within process flow 300 that is responsible for facilitating communication and securely transmitting payment information between the customer (e.g., cardholder 102), the merchant (e.g., merchant 108), and a payment processor (e.g., payment processor 310). Acquiring processor 116 may be in communication with payment processor 310, and payment processor 310 may provide services including but not limited to fraud detection, chargeback management, compliance with payment regulations, and/or processing transactions.

Payment processor 310 may be responsible for facilitating the transaction by processing and authorizing payments, as well as ensuring the secure transfer of funds between the customer's bank (e.g., issuer 110) and the merchant's bank (e.g., merchant bank 114). Payment processor 310 may require merchant 108 to establish a merchant account 312 to process transactions. Payment processor 310 may act as an intermediary between the customer's bank (e.g., issuer 110) and the merchant's bank (e.g., merchant bank 114, and/or acquiring processor 116), ensuring that funds move securely from customer account 314 to merchant account 312. Customer account 314 may be the same as, similar to, or related to cardholder account 106. Acquiring processor 116 transmits transaction data via arrow 5 to merchant account 312 of merchant 108 held at merchant bank 114.

Issuing stage 304 illustrates the flow of transaction data of the transaction between related entities such as the various issuing entities as shown in FIG. 1. As part of issuing stage 304, transaction data is transmitted via arrow 6 from payment processing network 104 to issuer processor 118. Transaction data is transmitted from issuer processor 118 via arrow 7 to customer account 314 of customer (e.g., cardholder 102) held at issuer 110. Arrows 8 and 9 show the relation between the customer (e.g., cardholder 102), customer account 314 (e.g., of cardholder 102), and issuer 110 (e.g., issuer 110 being the issuer bank of cardholder 102).

A risk and fraud provider 316 may be a connective component with each of acquiring stage 302 and/or issuing stage 304. Risk and fraud provider 316 may be an entity that provides risk and fraud services, such as fraud and chargeback management and/or prevention technology.

With reference to FIGS. 1 and 2, a computing system of acquiring processor 116, issuer processor 118, ISO/MSP 306, payment gateway 308, payment processor 310 and/or risk and fraud provider 316 may be embodied as an additional computing system 224, for example.

By virtue of process flow 300, a transaction processing device 112 embodied as a POS terminal is able to leverage the GALF model described herein to determine (a) likelihood of fraud, to then submit the transaction to payment processing network 104, and (b) offer real-time, personalized loyalty rewards that are based, for example, on customer data and/or merchant preferences. Offers available and/or presented to a cardholder may be referred to herein as a cardholder offer. Any communications between the various entities shown in FIG. 3 may be done by way of the applicable messaging standard, such as ISO/IEC 7816 and/or ISO 8583, as described herein.

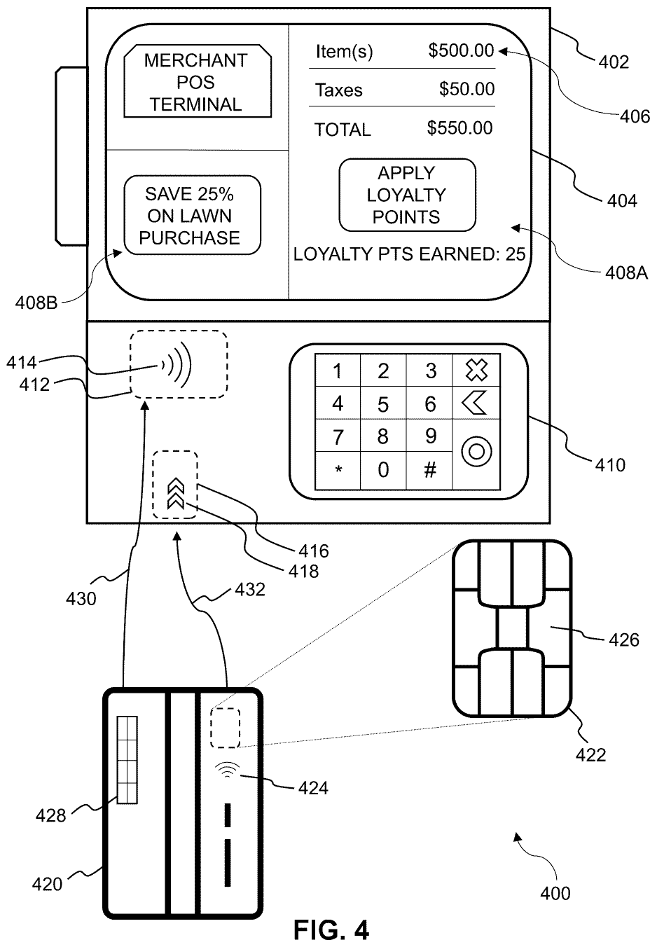

FIG. 4 illustrates an example configuration 400 of a transaction processing device and payment card according to one embodiment of the present disclosure. As shown in FIG. 2, transaction processing device 112 is operatively connected and in communication with GALF computing system 120 so that transactions processed via transaction processing device 112 are processed via the GALF model described herein. In FIG. 4, transaction processing device 112 is embodied as a POS terminal 402, including a screen 404 configured to display information such as purchase information 406 and loyalty rewards information 408A and offer information 408B. POS terminal 402 may also include a keypad 410, a tap-to-pay component 412 including tap-to-pay indicia 414, and a payment card insert component 416 including card insert indicia 418. Card insert component 416 may be adjacent a payment card insert slot (not shown) where intelligent microchip payment card 420 is inserted. Intelligent microchip payment card 420 includes an intelligent payment microchip 422 and tap-to-pay indicia 424 that informs cardholder 102 of which portion of payment card 420 to tap to POS terminal 402 for tap-to-pay usage. Tap-to-pay indicia 414 and card insert indicia 418 may be provided on an external surface of the housing of POS terminal 402 so as to provide a customer such as cardholder 102 with a visible indicator as to where to tap or insert payment card 420, and may be printed/etched/otherwise provided on the housing surface of POS terminal 402.

Keypad 410 may be configured with a plurality of number buttons and/or other buttons including but not limited to a YES/ENTER (e.g., green) button and a CANCEL/NO (e.g., red) button. For example, once payment card 420 is inserted into POS terminal 402, cardholder 102 may be asked to answer certain questions by physically pressing the button(s) corresponding to the desired answer.

Tap-to-pay component 412 may be a hardware component located within a housing of POS terminal 402, and may include a power coil and corresponding electronics and software configured to provide wireless power to payment cards having a compatible payment microchip. Card insert component 416 may be a hardware component located within the housing of POS terminal 402, and may include a contacts and/or pins that align with contact pads of the payment microchip such that power and/or data connections are provided to payment microchip 422. Intelligent payment microchip 422 includes one or more contacts pads 426 configured to interface with corresponding pins and/or contacts of card insert component 416. For example, payment card 420 needs to be inserted in the proper orientation so that contact pads 426 physically touch mating pins/contacts associated with card insert component 416. Payment microchip 422 may, in some embodiments, have a dedicated contact such as 426 for processing tasks for the Gen AI model(s) stored thereon, whereas in other embodiments a non-dedicated contact 426 may be utilized for such functions.

In some embodiments, payment card 420 may include an embedded alternative power source 428 configured to provide power to payment chip 422 without the need for being powered by POS terminal 402. Alternative power source 428 may, for example, be configured as (i) a solar panel array capable of converting light into electrical energy for powering payment chip 422, and/or (ii) an energy storage device such as a capacitor and/or a battery configured in an ultra-thin and/or small profile form factor capable of powering payment chip 422. Such alternative power sources may be configured to provide power for only a short duration of time based on limitations in the amount of energy capable of being stored in a small footprint such as a credit card. For example, in an embodiment where alternative power source 428 is configured as an energy storage device without a solar panel array, alternative power source 428 may be re-charged each time payment card 420 is inserted into POS terminal 402. Payment microchip 422 may be configured with a wireless antenna and software that allows for payment microchip 422 to be updated via wireless communications (e.g., WiFi, cellular network) without the need for being inserted into or tapped against POS terminal 402. Having such capabilities may be useful in situations where a merchant's network is down, reduced reliance on external systems, and/or to provide additional redundancy. These examples of alternative power sources are not limiting and other power sources may be implemented.

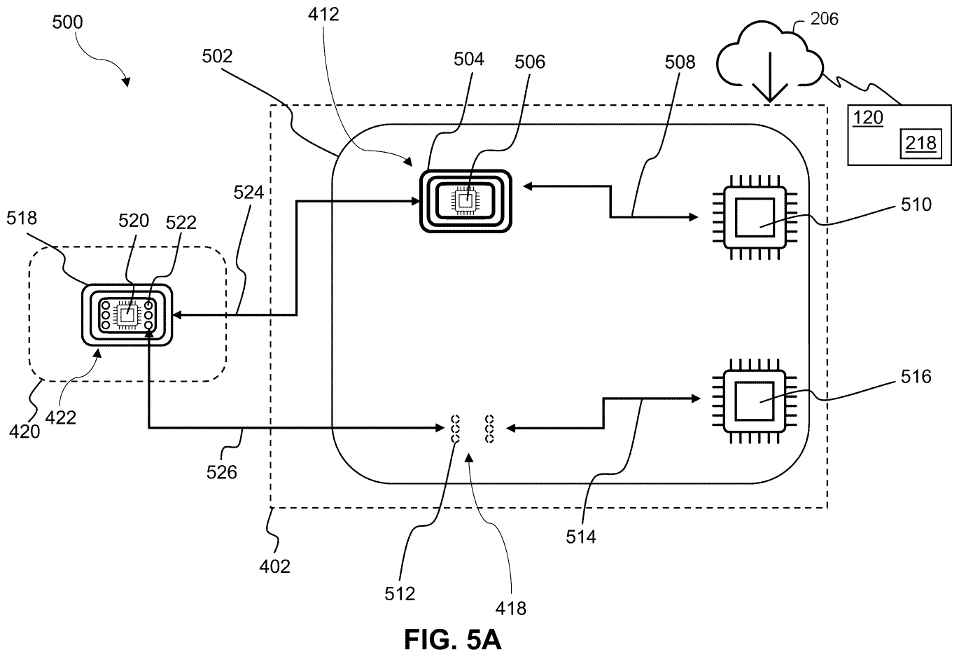

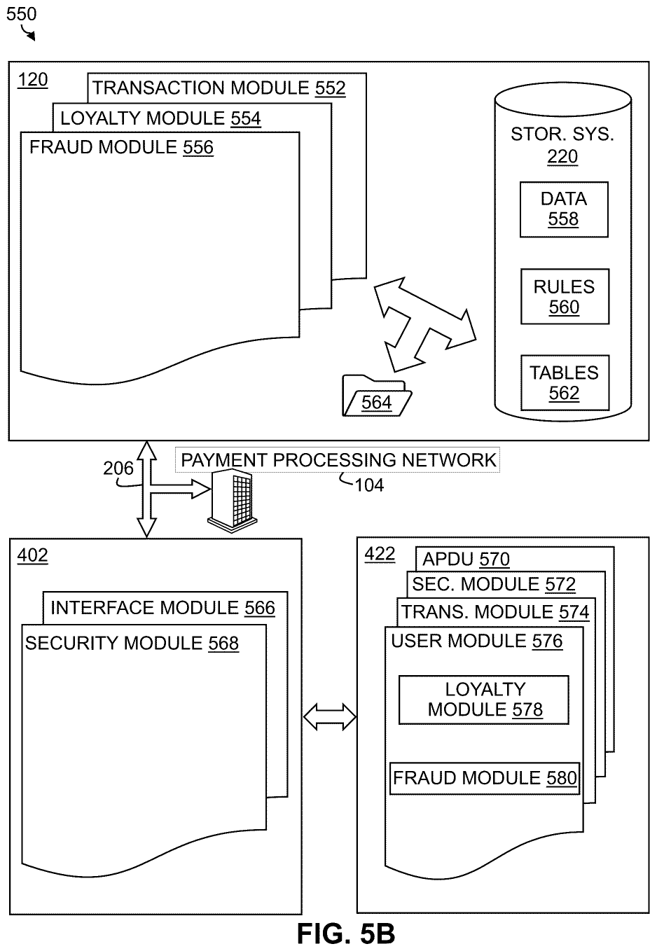

Arrow 430 illustrates tap-to-pay usage, where indicia 424 of payment card 420 is to be tapped to indicia 414 of POS terminal 402 to achieve tap-to-pay functionality and an inductive power state in which software stored on payment microchip 422 can be run. Area 432 illustrates an insert usage where payment card 420 is inserted into POS terminal 402 so that payment microchip 422 physically touches corresponding pins and/or contacts located within POS terminal 402. For example, there may be an insert slot adjacent insert indicia 418 for insertion of payment card 420 therein. Each of tap-to-pay component 412 and card insert component 416 may be part of an associated circuit board (shown in FIG. 5A) stored within POS terminal 402. Contact pads 426 may be configured to correspond to requirements of standards such as an EMV contact pad standard to ensure compatibility.

FIG. 5A is a diagram illustrating an example embodiment of a hardware configuration 500 of a transaction processing device (e.g., transaction processing device 112) in the form of a POS terminal (e.g., POS terminal 402) and a payment microchip (e.g., payment microchip 422) of a payment card (e.g., payment card 420).

FIG. 5A illustrates one embodiment of a printed circuit board (“PCB”) 502 of POS terminal 402 including thereon physical hardware for tap-to-pay component 412 and card insert component 416. PCB 502 may be one or more interconnected PCBs. Tap-to-pay component 412 may include power coils 504 and a controller 506, where controller 506 may control various aspects of tap-to-pay component 412, including but not limited to control schemes for powering power coils 504 and/or data transmission. In some embodiments, controller 506 may be configured to include near-field-communication (“NFC”) functionality for communication with an NFC-enabled mobile phone and/or in the case that payment microchip 422 is NFC-enabled. In other embodiments, a separate NFC chip in operative communication with controller 506 may be utilized. Controller 506 may be configured to in operative and/or electrical connection via connection 508 with other integrated circuits on PCB 502 such as integrated circuit (“IC”) 510. Connection 508 may be a conductive trace on PCB 502. PCB 502 may be a multi-layered PCB including conductive vias, lands, etc. for the connection of components thereon and communication between the components, using various layers of the PCB. IC 510 may be a multi-function IC configured to provide a plurality of functions including but not limited to data transfer between controller 506 and other components of POS terminal 402. POS terminal 402 may include wired, wireless, and/or other network connectivity options.

PCB 502 may also include a plurality of pins or contacts 512 configured to physically and electrically mate with contact pads 426 (shown in FIG. 4) of payment microchip 422. Plurality of pins or contacts 512 may correspond to contact pads 426 and may be in operative and/or electrical connection via connection 514 with integrated circuit (“IC”) 516. IC 516 may be a multi-function IC configured to provide a plurality of functions including but not limited to power and/or data transfer between controller 506 and other components of POS terminal 402. Plurality of pins or contacts 512 may be physically located on a side of PCB 502 opposite from a side on which power coils 504 are present.

Payment microchip 422 of payment card 420 may be configured to include power coils 518, a controller 520, and contacts 522. Power coils 518 may be configured to inductively mate with power coils 504 of PCB 502 so that POS terminal 402 provides power to payment microchip 422, enabling controller 520 to be powered. Controller 520 may include memory for storing GALF models (shown in FIG. 6).

When payment microchip 422 of payment card 420 is tapped to tap-to-pay component 412, coils 504 inductively couple with coils 518 to provide power to controller 520 so that controller 520 may run code/software stored thereon. Controller 520 may also be configured with a communication mechanism such as NFC. Arrow 524 represents a wireless connection between coils 504 and 518 and/or controllers 506 and 520 via, for example, a wireless data protocol utilized by and implemented via controllers 506/520, such as NFC. Contacts 522 may be electrically connected to pins and/or ports of controller 520. Contacts 522 are electrically connected to contacts 426, for example by direct connection therebetween and/or conductive elements such as conductive bond wires therebetween.

When payment card 420 is properly inserted into the payment card slot of POS terminal 402, contact pads 426 physically touch plurality of pins or contacts 512 and signals may be transmitted between contact pads 426 and contacts 522. Arrow 526 represents a physical connection between plurality of pins or contacts 512 and contact pads 426. For example, each contact pad 426 (and corresponding underlying contact 522) may correspond to a dedicate pin or contact of plurality of pins or contacts 512 for establishing an electrical connection therebetween.

In operation, once payment microchip 422 is powered either via inductively coupled coils 504/518 or directly coupled via contact pads 426 and plurality of pins or contacts 512, GALF models stored thereon may run and/or be updated. This may include downloading and/or running instructions and/or other code provided via a network connection (e.g., wired or wireless) of POS terminal 402, which may be configured with a physical data connection port such as an ethernet port and/or wireless communication module such as a WiFi module to connect, for example, to a network such as network 206 shown in FIG. 2. For example, ICs 510/516 and/or other microchips (not shown) of PCB 502 may be configured to provide wireless communication functionality to POS terminal 402. PCB 502 may include local memory thereon for storage of programs, rules, and other software for operating POS terminal 402 itself and in connection with connected systems such as GALF computing system 120, payment microchip 422, and/or any other entities and/or relationships shown in FIGS. 1-3.

For wireless data transfer, an NFC information transfer process may be utilized and implemented and may include the following: (1) initiation, where the customer taps their NFC-enabled payment card or payment device (such as a smartphone) near the POS terminal's NFC reader; (2) data exchange, where the NFC chip in the payment card or payment device communicates (wirelessly) with the NFC reader in the POS terminal using radio waves; (3) secure transmission, where the payment card may, in some embodiments, sends a one-time code containing the payment information to the POS terminal, where such code may be encrypted to ensure security; (4) authorization, where the POS terminal forwards the transaction details to the payment processor, which then verifies the transaction with the card issuer; and (5) confirmation, where, once the transaction is authorized, the POS terminal indicates the approval of the transaction to the customer and/or merchant cashier.

FIG. 5B is a block diagram 550 illustrating software modules of each of GALF computing system 120, POS terminal 402, and payment microchip 422 according to one embodiment of the present disclosure.

GALF computing system 120 may include a transaction module 552, a loyalty module 554, and a fraud module 556. GALF computing system 120 may include or be operatively connected to storage system 220, which may store therein a plurality of data 558, a plurality of rules 560, a plurality of tables 562, and/or a plurality of cardholder profiles 564. Other storage devices/systems as described herein may also be used to store such data/information/rules.

Transaction module 552 may be configured and implemented to integrate with merchant and/or banking infrastructure and systems (such as computing systems 202 and 204) for storing transaction data, which may be stored as part of data 558 in storage system 220. This transaction data may be used in conjunction with AI/ML module 218 (shown in FIG. 2) to train and/or update the GALF model of GALF computing system 120. Transaction module 552 may be configured to include and utilize transaction processing logic that may include transaction tracking, labeling, and other related parsing and grouping of transaction data. Storage system 220 may be configured to include a delineated portion of storage that functions as a transaction database for storing transaction data associated with cardholders. Transaction data may be logged and tracked to record all transactions made by payment card 420. Transaction module 552 may include reporting and querying functionalities according to transaction rules that may be stored within rules 560. Transaction module 552 may further be configured to operate based on intelligence-based rules stored within rules 560. Transaction module 552 may be configured to store various formatted transaction data within corresponding tables of tables 562 for ease of lookup and retrieval. Transaction data history for each cardholder may be stored in respective cardholder profiles 564. Cardholder profiles 564 may store preferences, spending patterns, cardholder trends, and/or any other pertinent information regarding cardholder behavior and/or payment card usage. Transaction module 552 may further be configured to transmit confirmation and notification messages (e.g., in the form of ISO-8583 messages). GALF computing system 120 and the corresponding banks (e.g., 110, 114) may maintain logs of all transactions for audit and compliance purposes. Within GALF computing system 120, such logs may be stored in storage system 220.

Cardholder profiles 564 may be stored within storage system 220 or other memory associated with GALF computing system 120, such as a dedicated cardholder profile database/server (e.g., database 212 may be configured and implemented for such purposes). Database 212 may be configured to function as supplemental storage for storage system 220, or may be integrated within storage system 220. Storage system 220 and/or database 212 may be partitioned or otherwise configured in any plurality of manners for data storage and retrieval, and/or in edge computing configurations as described herein.

GALF computing system 120 may further be configured to include a loyalty module 554. In one embodiment, a loyalty rewards program may be configured and structured to include: (1) customer profiles, for storing customer information such as customer names, contact details, and/or loyalty program membership status; (2) earn rules, to specify how points can be earned; (3) redemption rules, to specify how and when points can be redeemed; (4) points management, including a points system and tracking of points earned by customers based on their purchases and/or other incentives; and (5) points tiers to define different levels of status and/or rewards based on points earned. Technical features of such a loyalty rewards programs may include: (1) user authorization/authentication, to ensure secure login and access control for customers and/or administrators; (2) security, including data encryption to ensure protection of sensitive customer data and other information; (3) transaction integration, including POS terminal connection/integration to automatically update customer points based on purchases; (4) APIs to provide seamless integration with other systems such as POS terminals and platforms such as e-commerce platforms; (5) a communication module, which may be configured to prepare and send (i) email notifications such as personalized emails to customers about their points balance, rewards earned, and/or special offers, (ii) push notifications, to deliver real-time notifications to customers'mobile devices about loyalty program updates, and/or (iii) system messages; (6) analytics and reporting, which may, on the front-end, include providing a dashboard to users for viewing rewards information such as points earned, points redeemed, etc., and, on the back-end, include generating detailed reports on program performance, customer behavior, and return-on-investment, and performance monitoring to track the effectiveness of the program and/or provide insights for improvement/optimization; (7) administration control, which may be configured to allow administrators to create and manage loyalty campaigns, set rules, and target specific customer segments; (8) compliance with industry standards and regulations such as GDPR and PCI DSS; and (9) scalability and flexibility, allowing for easy updates and additions to the loyalty program without disrupting existing functionality.

Loyalty module 554 of GALF computing system 120 may be configured to implement the above-noted technical features, and may include therein APIs and various modules including but not limited to a user authorization/authentication module, a security module, a communication module, an analytics/reporting module, an administration module, and a compliance module, for example. In some embodiments, rules defining a merchant's loyalty program may be stored within a memory of a terminal such as POS terminal 402, and/or within memory such as storage system 220 as part of rules 560. These loyalty rules may include earn rates and other parameters of the loyalty program as described herein.

GALF computing system 120 also may include a fraud module 556 which may be configured and implemented to generate fraud parameters based, for example, on a user's spend and/or transaction behavior, and used in connection with detecting fraudulent spending/transaction activity. Fraud parameters may be set in conjunction with patterns learned by AI/ML module 218, and may also take into account historical fraud data of any plurality of users, for example as collected by an entity such as a payment network provider, and/or utilize other fraud determination data, algorithms, rules, and/or tools that such an entity may have developed over the years. This may include intelligence-based fraud rules which may be stored as part of rules 560. Fraud module 556 may be configured to analyze historical data, such as via AI/ML module 218, to learn user spend and transaction patterns and determine what constitutes a valid transaction as compared to a potentially fraudulent transaction. This learned knowledge may be used to form and define fraud parameters for users. Fraud parameters may include any spend and/or other transaction data that may assist in building a fraud profile as part of cardholder profiles 564 and used to detect potential fraud. Fraud parameters may include information pertaining to normal purchase amounts, normal purchase times/locations/frequencies (e.g., transaction velocity), and likewise abnormally high-dollar purchases, and/or purchases with abnormal frequency, time, and/or location, and the like. Such fraud detection may be complemented by fraud protection aspects, where GALF computing system 120 may generate notices or other warnings to the administrators and/or users in connection with suspicious activity. Fraud module 556 may be configured to implement an AI-based fraud model as shown in and described in connection with FIG. 6. Cardholder profiles 564 may store individualized data and information for each cardholder 102, including individualized transaction, loyalty, and fraud profiles for each cardholder.

POS terminal 402 may include an interface module 566 and a security module 568. Interface module 566 of POS terminal 402 may be configured and implemented to interface with GALF computing system 120 via network 206 associated with payment processing network 104. This may include the use of APIs and/or other software for integration with the systems and entities shown in FIGS. 1-3.

Security module 568 of POS terminal 402 may be configured and implemented to provide secure authorization and authentication mechanisms as described herein, which may include implementation of industry standard encryption protocols to secure user data and transactions, such as PCI DSS. Security module 568 may be configured and implemented to use encryption protocols such as secure sockets layer (“SSL”) and transport layer security (“TLS”) to secure data transactions between the terminal and a central server such as payment network server 208, and may include anti-virus/anti-malware software to help detect and remove potential threats on an ongoing basis.

Payment microchip 422, via controller 520 and/or any associated local memory, for example, may be configured and implemented to include an APDU 570, a security module 572, a transaction module 574, and a user module 576 which may include a loyalty module 578 and a fraud module 580.

APDU 570 may be configured and implemented to provide commands and responses for communication between payment microchip 422 and a terminal such as a POS terminal 402 configured to accept payment cards. Examples of APDU commands may include instructions sent from POS terminal 402 to payment microchip 422 to perform tasks including but not limited to reading/writing data and/or authentication. APDU responses may include a reply of payment microchip 422 to the commands, where the responses may contain the requested data, a status indicating the result of the command (e.g., success, error), etc. APDU commands and responses may formatted and implemented in accordance with the ISO/IEC 7816 standard.

Security module 572 may be configured and implemented the same as or similar to security module 568 of POS terminal 402, and may include security algorithms including encryption and/or authentication algorithms to ensure secure transactions as described herein.

Transaction module 574 of payment microchip 422 may be configured and implemented to process transaction data of a cardholder 102, which may be performed in conjunction with AI/ML module 218, for example, and/or other intelligence-based transaction rules. Transaction module 574 may be configured to include one or more payment applications, including applications that manage payment processes, such as authorization and settlement.

User module 576 of payment microchip 422 may be configured and implemented to store thereon (i) personal data relating to the cardholder, such as name, account number, and payment card expiration date, (ii) a loyalty module 578, and (iii) a fraud module 580. In some embodiments, a loyalty module 578 and/or fraud module 580 may be individual modules separate from user module 576 but still stored within a memory of payment microchip 422.

Transaction module 574, may, in association with user module 576, be configured and implemented to perform card authentication and verification, communicate with payment processing network 104 to authorize the transaction, and/or generate (e.g., unique) transaction codes for each transaction.

Loyalty module 578 may be configured and implemented to both execute and apply an output of a GAL model to a transaction. Similarly, fraud module 580 may be configured and implemented to both execute and apply an output of a GAF model to a transaction. For example, a GAL model may be stored in loyalty module 578, and a GAF model may be stored in fraud module 580. The GAL and GAF models are described in more detail in connection with FIG. 6.

Each module described herein may comprise computer code and/or other software and/or hardware components as part of GALF computing system 120, POS terminal 402, and/or payment card 420, and may be configured to interface with one another for operation of GALF computing system 120 and POS terminal 402 for transactions made via payment card 420. The data, tables, etc. stored within the modules shown in FIG. 5B may be stored in a respective storage device of each component, and/or in a centralized storage device such as storage system 220 shown in FIG. 2, which may be local to GALF computing system 120 or cloud-based, for example. Moreover, each of the above-described modules may be configured for (i) interoperability via implementation of various APIs configured to allow for the various systems and/or system components to communicate, share data, and perform applicable processes, and/or (ii) edge computing as described herein.

In some embodiments, the transactions and/or processes shown in and described in connection with FIGS. 4, 5A, and 5B may take place at the edge (e.g., edge 228 shown in FIG. 2) of the network of subsystem 200 to achieve edge computing benefits as described herein. For example, the updating and/or execution of a GALF model on payment microchip 422 may primarily take place at the edge, such as at POS terminal 402. By storing the models on the payment card and executing the models via the payment card, fraud and loyalty determinations can be performed at the card level, without the need for fraud and/or loyalty decisions to be in a centralized manner relative to payment processing network 104. The payment microchip is configured to approve the transaction from a fraud perspective by embedding a result of the fraud determination output from the GAF model in a message without further analysis needing to be performed, for example, by the card issuer. This can speed up transactions, as the only deliberation is whether or not the cardholder has sufficient funds to cover the amount of the transaction.

FIG. 6 is a schematic diagram 600 illustrating further detail of exemplary AI/ML module 218 (shown in FIG. 2). AI/ML module 218 may be in operative communication with other components of subsystem 200, such as database server 208 (or a third-party server), client systems 204 via network 206 (shown in FIG. 2), etc. AI/ML module 218 may include and/or be in communication with a database 602 that stores data 604 including at least transaction data. Data 604 received from network 206 may be stored in database 602. Database 602 may be a standalone database within subsystem 200, part of database 212, and/or part of storage system 220 (in which case data 604 may be stored as part of data 558). In some embodiments, database 602 may be a dedicated database for AI/ML module 218, and may be local or cloud-based, where a local database may be implemented as part of an edge computing configuration as described herein. Data 604 may include transaction data and a variety of other data relating to transactions, such as loyalty and/or fraud data.

AI/ML module 218 may be configured to use data 604 as part of using a GAL model module 606 to generate a GAL model, where GAL model module 606 may be configured and implemented to control and/or implement certain operations of AI/ML module 218 or vice versa. AI/ML module 218 may further be configured to generate action recommendations in response to operational requests. GAL model module 606 may be integrated within or otherwise in operative communication with loyalty module 554 shown in FIG. 5B.

In exemplary embodiments, AI/ML module 218 includes a training set builder module 608 configured to submit one or more queries 610 to database 602 to retrieve subsets 612 of data 604, and to use those subsets 612 to build training data sets 614 for generating the GAL model via the machine-learning GAL model module 606. In some embodiments, data 604 may have been parsed and stored in tables such as part of tables 562. For example, query 610 may be configured to retrieve certain fields from tables of data 604 for historical transactions originated by certain POS terminals or merchants, transaction histories for respective cardholders, and the like.

In exemplary embodiments, training set builder module 608 may be configured to derive training data sets 614 from retrieved subsets 612. Each training data set 614 corresponds to a historical data 604 (“historical” in this context means completed in the past, as opposed to completed in real-time with respect to the time of retrieval by training set builder module 608). Each training data set 614 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 614 may be generated from data fields in subset 612 corresponding to historical data 604. In other words, a trained machine learning model 616 produced by a model trainer module 618 for use by GAL model module 606 is trained to make predictions based on input values that can be generated from the data fields in data 604. Values in the model input data fields may include values copied directly from values in a corresponding data field in the retrieved subset 612, and/or values generated by modifying, combining, or otherwise operating upon values in one or more data fields in the retrieved subset 612. The use of such data fields as model input data fields facilitates the machine learning model in weighing these factors directly.

After training set builder module 608 generates training data sets 614, training set builder module 608 passes the training data sets 614 to model trainer module 618. In example embodiments, model trainer module 618 is configured to apply the model input data fields of each training data set 614 as inputs to one or more machine learning models. Each of the one or more machine learning models is programmed to produce, for each training data set 614, at least one output intended to correspond to, or “predict,” a value of the at least one result data field of the training data set 614. “Machine learning” refers broadly to various algorithms that may be used to train the model to identify and recognize patterns in existing data in order to facilitate making predictions for subsequent new input data.

Model trainer module 618 is configured to compare, for each training data set 614, the at least one output of the model to the at least one result data field of the training data set 614, and apply a machine learning algorithm to adjust parameters of the model in order to reduce the difference or “error” between the at least one output and the corresponding at least one result data field. In this way, model trainer module 618 trains the machine learning model to accurately predict the value of the at least one result data field. In other words, model trainer module 618 cycles the one or more machine learning models through the training data sets 614, causing adjustments in the model parameters, until the error between the at least one output and the at least one result data field falls below a suitable threshold, and then uploads at least one trained machine learning model 616 to GAL model module 606 for application to generating recommendations 620. In exemplary embodiments, model trainer module 618 may be configured to simultaneously train multiple candidate machine learning models and to select the best performing candidate for each result data field, as measured by the “error” between the at least one output and the corresponding result data field, to upload to GAL model module 606.

As model trainer module 618 cycles through the training data sets 614, model trainer module 618 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 618 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

AI/ML module 218 of the present disclosure is configured to operate on input data related to financial transactions, access additional data, identify loyalty patterns, and identify fraudulent and non-fraudulent transactions (described below). In one exemplary embodiment, AI/ML module 218 executes the GAL model module 606 programmed to learn, without limitation, outcomes of loyalty points-earning transactions based upon varying events and details, relevant data sources for evidence, the queries used to prompt a user to provide relevant information, features of financial transactions related to loyalty points, and the like.

To facilitate this learning, AI/ML module 218 includes one or more of database 602 at which the data, including requests, responses, feature codes, evidence, outcomes, etc., is stored. This data becomes one or more input training sets used by training set builder 608. Model outputs can be formatted for presentation or review as visual representations of recommendations, as text-based or natural language recommendations, and the like. In exemplary embodiments, GAL model module 606 may compare feedback, and may route a comparison result 622 generated by comparing recommendation 620 to the feedback to a model updater module 624 of AI/ML module 218. Model updater module 624 is configured to derive a correction signal 626 from comparison results 622 received for one or more recommendations and to provide correction signal 626 to model trainer module 618 to enable updating or “re-training” of the at least one machine learning model to improve performance. The retrained at least one machine learning model 616 may be periodically re-uploaded to GAL model module 606. GAL model module 606 may be configured to provide an output 628 that may be used in a variety of ways, as described herein. Output 628 may include, for example, the latest GAL model and parameters thereof.

AI/ML module 218 may also be configured to use data 604 (and/or an output from GAL model module 606, for example in the case where loyalty rewards patterns may be beneficial in predicting and detecting fraud) to generate and/or be used in association with a GAF model module 630 for generating and providing a fraud detection and/or prediction model for implementing fraud-based operations of AI/ML module 218, and generating action recommendations in response to operational requests, and the like.

AI/ML module 218 may be configured to use data 604 as part of using a GAF model module 630 to generate a GAF model, where GAF model module 630 may be configured and implemented to control and/or implement certain operations of AI/ML module 218. GAF model module 630 may be integrated within or otherwise in operative communication with fraud module 556 shown in FIG. 5B.

In exemplary embodiments, AI/ML module 218 includes a training set builder module 632 that is configured to submit one or more queries 634 to database 602 to retrieve subsets 636 of data 604, and to use those subsets 636 to build training data sets 638 for generating a fraud model via GAF model module 630. For example, query 634 may be configured to retrieve certain fields from data 604 for historical data including past fraudulent transactions and characteristics of such, including fraud data originated by certain POS terminals or merchants, transaction history for a customer, and the like.

In exemplary embodiments, training set builder module 632 may be configured to derive training data sets 638 from retrieved subsets 636. Each training data set 638 corresponds to a historical data 604 (“historical” in this context means completed in the past, as opposed to completed in real-time with respect to the time of retrieval by training set builder module 632). In one example scenario, if multiple online transactions are made in quick succession at a retailer that the cardholder has never shopped at before, the fraud model may flag any next transaction as fraudulent due to the detect transaction anomalies and the next transaction being temporally adjacent other likely fraudulent transactions. Each training data set 638 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 638 may be generated from data fields in subset 636 corresponding to historical data 604. In other words, a trained machine learning model 640 produced by a model trainer module 644 for use by GAF model module 630 is trained to make predictions based on input values that can be generated from the data fields in data 604. Values in the model input data fields may include values copied directly from values in a corresponding data field in the retrieved subset 636, and/or values generated by modifying, combining, or otherwise operating upon values in one or more data fields in the retrieved subset 636. The use of such data fields as model input data fields facilitates the machine learning model in weighing these factors directly. Fraud tables may be stored as part of tables 562 for such purposes.

After training set builder module 632 generates training data sets 638, training set builder module 632 passes the training data sets 638 to model trainer module 644. In example embodiments, model trainer module 644 is configured to apply the model input data fields of each training data set 638 as inputs to one or more machine learning models, such as GAF model module 630. Each of the one or more machine learning models is programmed to produce, for each training data set 638, at least one output intended to correspond to, or “predict,” a value of the at least one result data field of the training data set 638.

Model trainer module 644 is configured to compare, for each training data set 638, the at least one output of the model to the at least one result data field of the training data set 638, and apply a machine learning algorithm to adjust parameters of the model in order to reduce the difference or “error” between the at least one output and the corresponding at least one result data field. In this way, model trainer module 644 trains the machine learning model to accurately predict the value of the at least one result data field. In other words, model trainer module 644 cycles the one or more machine learning models through the training data sets 638, causing adjustments in the model parameters, until the error between the at least one output and the at least one result data field falls below a suitable threshold, and then uploads at least one trained machine learning model 640 to GAF model module 630 for application to generating recommendations. In exemplary embodiments, model trainer module 644 may be configured to simultaneously train multiple candidate machine learning models and to select the best performing candidate for each result data field, as measured by the “error” between the at least one output and the corresponding result data field, to upload to GAF model module 630.

As model trainer module 644 cycles through the training data sets 638, model trainer module 644 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 644 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

AI/ML module 218 of the present disclosure is configured to operate on input data related to financial transactions, access additional data, and generate analysis identifying fraudulent and non-fraudulent transactions. In one exemplary embodiment, AI/ML module 218 executes the GAL model module 606 and the GAF model module 630 programmed to learn, without limitation, outcomes of transactions based upon varying events and details, relevant data sources for evidence, the queries used to prompt a user to provide relevant information, features of financial transactions related to potential fraud, and the like.

To facilitate this learning, AI/ML module 218 includes one or more databases 602 at which the data, including requests, responses, feature codes, evidence, outcomes, etc., is stored. This data becomes one or more input training sets used by the training set builder 632. Model outputs can be formatted for presentation or review as visual representations of recommendations, as text-based or natural language recommendations, and the like. In exemplary embodiments, GAF model module 630 may compare feedback, and may route a comparison result 642 generated by comparing recommendation to the feedback to a model updater module 646 of AI/ML module 218. Model updater module 646 is configured to derive a correction signal 648 from comparison results 642 received for one or more recommendations and to provide correction signal 648 to model trainer module 644 to enable updating or “re-training” of the at least one machine learning model to improve performance. The retrained at least one machine learning model 640 may be periodically re-uploaded to GAF model module 630. GAL model module 606 and GAF model module 630 may be referred to individually as separate machine learning modules, or as being within a machine learning module (e.g., the machine learning module includes both the GAL model module and the GAF model module). Output 628 may include trained model 616 (e.g., a trained GAL model), and output 650 may include trained model 640 (e.g., a trained GAF model).

Trained models 616 and 640 may be loaded onto memory 652 of controller 520 so that memory 652 includes thereon an instance 654 of trained loyalty model 616 and an instance 656 of trained fraud model 640 which may be deployed during use of payment card 420 at a POS terminal such as POS terminal 402 as described herein. The GAL model from GAL model module 606 and the GAF model from GAF model module 630 may be referred to in combination as GALF model(s). GALF executable file 658 may include each of the GAL model and the GAF model, and may be executed by controller 520 of payment microchip 422 to run the GAL and GAF models locally at a POS terminal 402 as described herein. GALF executable file 658 may be able to be parsed by controller 520 to extract the GAL model and the GAF model. In some embodiments, GALF executable file 658 may be two separate files, one each for the GAL model and the GAF model. In some embodiments, payment microchip 422 may have memory and/or other circuit components such as dedicated processor located thereon that are dedicated specifically for storing and or running a Gen AI model. When deployed at the card level via execution by the payment microchip, trained GAL model 616 may output loyalty results relating to a given transaction, and trained GAF model 640 may output fraud results relating to the given transaction. Such loyalty results may be based on a comparison of parameters of the transaction to a cardholder profile (e.g., cardholder profile 564 shown in FIG. 5B) associated with the Gen AI loyalty and fraud model. Each of the fraud results and the loyalty results may be based on information present in the cardholder profile of the cardholder. The loyalty results may be applied to the transaction and may include: (i) presenting the cardholder with one or more offers relating to the transaction; (ii) tracking loyalty points associated with the transaction; (iii) providing the cardholder with an option to apply loyalty points to the transaction; and (iv) awarding loyalty points for the transaction. Each of (i) the presenting the cardholder with one or more offers relating to the transaction; (ii) the tracking loyalty points associated with the transaction; (iii) the providing the cardholder with an option to apply loyalty points to the transaction; and (iv) the awarding loyalty points for the transaction is based at least on personalized analysis by the Gen AI fraud and loyalty model of historical transaction patterns of the particular cardholder. Once the loyalty results and fraud results are applied to the given transaction, they may be used as inputs to update the respective models accordingly with new data. Offers and/or incentives may be stored in cardholder profile 564 according to offer/incentive rules (which may be stored as part of rules 560) of a merchant and/or card provider. The stored offers/incentives may be loaded for a given transaction upon a determination by the GALF model(s) that the transaction includes parameters that trigger the offers/incentives to be applied.

In some embodiments, GAL model module 606 and GAF model module 630 may be configured to have a working (e.g., symbiotic) relationship where GAL model module 606 outputs to training set builder module 632 of GAF model module 630 so that each model learns and grows over time to better determine, predict, and/or label fraud in cases where loyalty patterns may be dispositive in making fraud determinations. Additionally, or alternatively, GAF model module 630 may be configured to feed GAL model module 606, where an on output (e.g., output 650) from GAF model module 630 may be fed into GAL model module 606 (e.g., via training set builder 608) so that GAL model module 606 operates according to the latest parameters of GAF model module 630. Other aspects of the two models may be shared with respect to the interfacing of the two models together, including but not limited to sharing of trained learning models 616, 640 and comparison results 622, 642 between the models (or any other aspects of the models shown in FIG. 6, such as correction signals 626, 648).

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

With reference to FIGS. 1-6, in one transaction scenario, a customer (e.g., cardholder 102) may purchase several items from a store, such as lumber and a lawn mower at a home improvement store. When the customer inserts their payment card (e.g., 420) into the POS terminal (e.g., 402), the latest GALF model(s) may be downloaded to the memory of the payment card. The GALF model(s) may then be deployed to determine if there are any offers and/or other loyalty incentives relating to the lumber and lawn mower purchase and for fraud purposes. If offers/incentives are present they may be presented on display screen 404 of POS terminal 402 as shown by loyalty rewards information 408A and offer information 408B in FIG. 4. For example, loyalty rewards information 408A may include displaying loyalty points associated with the transaction (e.g., an amount of points to be earned from the transaction), and providing the cardholder with an option to apply loyalty points to the transaction (e.g., via a physical button of keypad 410 and/or a virtual button on display screen 404). Offer information 408B may include display of one or more offers relating to the transaction. This may be implemented as a virtual badge or button on display screen 404, that when touched by the cardholder presents an option to apply the offer and/or an additional information screen outlining details of the offer. Such additional information and/or the option to redeem an offer, apply loyalty points, etc. may take place on a mobile device of the cardholder instead of, or in addition to, the POS terminal. For example, a text message may be sent to the mobile device of the cardholder requesting authorization to redeem a certain amount of loyalty points to cover all or part of the transaction amount. The offer/incentive may be automatically applied, or the customer may choose to select to use the offer/incentive. For example, the customer may decide whether to use the offer/incentive based on other parameters of the offer, such as any expiration date(s) thereof, limitations (e.g., excluded goods) thereof, or to save the offer/incentive for a subsequent purchase to maximize the return on the offer/incentive (e.g., use the offer/incentive on a higher dollar amount purchase).

In one usage scenario, a cardholder 102 may own a landscaping business, and may frequently buy related goods and/or equipment at a certain merchant. The GAL model may learn this behavior over time and present cardholder 102 with loyalty incentives to keep buying such landscaping-related items at the particular merchant. In another scenario, the merchant may be having a sale on lawn goods and equipment for any/all customers (e.g., not directly targeted to the cardholder having a landscaping business). In this case, the cardholder having the landscaping business may be presented with both personalized loyalty program incentives and sales promotions that are generally available to all customers, and may be able to stack such incentives/offers. For example, the landscaping cardholder 102 may have an individual/personalized loyalty incentive to earn an extra 5,000 loyalty points on purchases in a lawn equipment category. This personalized loyalty incentive may be able to be stacked with a general 20% off coupon for lawn equipment offered by the merchant, and/or any other personalized offers according to the terms of the offer. This may drive customer engagement and/or loyalty to a particular merchant and/or to the particular payment card and payment card provider offering such incentives/offers.

There are certain circumstances where a transaction may be subject to more stringent authentication. For example, further regarding the performing of a fraud check as part of the above-described home improvement store purchase scenario, the GAF model may, depending on determinations made regarding the details of the transaction, cause a message to be sent to the card issuer to issue a step-up-challenge to the cardholder. For example, a purchase of a very expensive item such as an expensive lawn mower may trigger a step-up challenge. With reference to FIG. 3, this may involve there being an additional field in a query request to a gateway that requests the card issuer perform a step-up challenge authentication. Based on the results of the step-up challenge, the transaction may be approved or denied. Such step-up challenge functionality may be provided in accordance with the 3DS 2 Protocol (and subsequent versions of the 3DS Protocol). If it is determined that cardholder step-up authentication is required, a server such as an access control server (not shown) may be configured to initiate a step-up challenge request. The results of the step-up challenge request may be transmitted in a message to a server such as a 3DS server (not shown), and ultimately to the cardholder. If step-up authentication is required, the access control server controls the step-up authentication in accordance with methods used for cardholders of the issuer (e.g., biometric authentication, one time password (OTP) authentication, short message service (SMS) authentication, etc.). The access control server and/or the 3DS server may be components within subsystem 200 shown in FIG. 2, such as integrated within payment network server 208, or be a standalone servers within subsystem 200, and/or otherwise integrated within process flow 300 shown in FIG. 3.

Controllers 506 and/or 520 may be configured to perform certain analysis of the transaction. In some embodiments, controller 520 of payment microchip 422 may, at the card level, perform computational processes to compare information of a current transaction to information present in the output of the GALF models to determine an offer to be presented to the cardholder, including any plurality of enumerated and/or target parameters of the current transaction. Such parameters of the current transaction may include but are not limited to an amount spent, an amount spent over a certain defined duration of time, categories of goods, manufacturer offers, and the like. For example, a merchant and/or retailer may be motivated to clear out old stock of items, and may incentivize customers to purchase such items (which helps clear out old inventory) via promotions such as elevated/bonus loyalty point earning promotions, discounts, etc. In other embodiments, controller 506 of POS terminal 402 may perform such computational processes. A determination as to which device performs which may perform computational processes may be determined based on the type of POS terminal being used for the transaction, network connectivity/availability, and various other considerations. For example, because the POS terminal will generally have greater processing capabilities than the payment microchip, controller 520 may be configured to perform only low-resource processing tasks at the card level, whereas controller 506 may be configured to perform processing tasks that require more processing power than is capable from and/or desired of the payment microchip. These settings may be configured within operating parameters of the POS terminal and/or the payment microchip, and may vary based both on POS terminal type and/or payment card/microchip type. Edge computing techniques as described herein may also be contemplated and utilized to maximize the ability to perform computations at the card level via microchip 422.

Another example scenario represents a cross-over of the loyalty and fraud aspects described herein. For example, it may be the case that a nefarious entity gains access to loyalty rewards accounts, and may try to use loyalty points for purchases instead of cash to evade detection. Because the GAF model may be trained with loyalty data, the GAF model is configured to be able to detect fraudulent purchases made with loyalty points as well. This may add an additional layer of protection to cardholders. For example, if a certain cardholder infrequently uses their loyalty rewards points, and then a sudden loyalty transaction draining almost all of the cardholder's points is made, this may trigger a fraud alert and corresponding additional review for fraud purposes.

The GAF model may include a predictive fraud model applying data (e.g., data including sets of long term variables (LTV's)) associated with spending behavior for card present and/or card-not-present transactions, such that when the legitimacy of a current transaction needs to be determined, the GAF model may be applied to the current transaction to generate a fraud determination in real-time for the current transaction without running all transactions or without having to rebuild those fraud models. LTV's are flexible and can be modified, added, or removed from the GAF model without having to rebuild the model, and can be collected and updated to the GAF model in near real-time. The one or more LTV's may include historical authentication data associated with the payment account number (PAN) at issue, historical authorization data associated with the PAN, other historical data associated with the PAN, etc. For example, the LTV may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the LTV's may be stored in a database (e.g., database 212) accessible by the GALF computing system and operated by the payment processing network. In some embodiments, LTV data will be hashed prior to storing to protect the security of this personally identifiable information.

Additional aspects of fraud prediction and detection via the GAF model may include analysis as to specific retailers frequented by a given cardholder, periodic transactions, seasonal transactions, and the like. For example, the GAF model may include rules and/or other learned parameters such as LTV's to analyze and categorize purchases in a variety of manners. This may span from analyzing year-over-year transactions of the cardholder, such as comparing purchases made by a cardholder in December of one year to those in December of a prior year, to comparing month-to-month transactions of the cardholder in any given calendar year, to analyzing all transactions by a cardholder at a particular merchant over a certain time period (e.g., six months), and so on and so forth. For example, beyond comparing December year-over-year purchases, the GAF model may also be programmed to know and/or learn that December is a seasonal (e.g., holiday) sales period, and may apply additional particularized analysis tailored to such a distinctive timeframe.

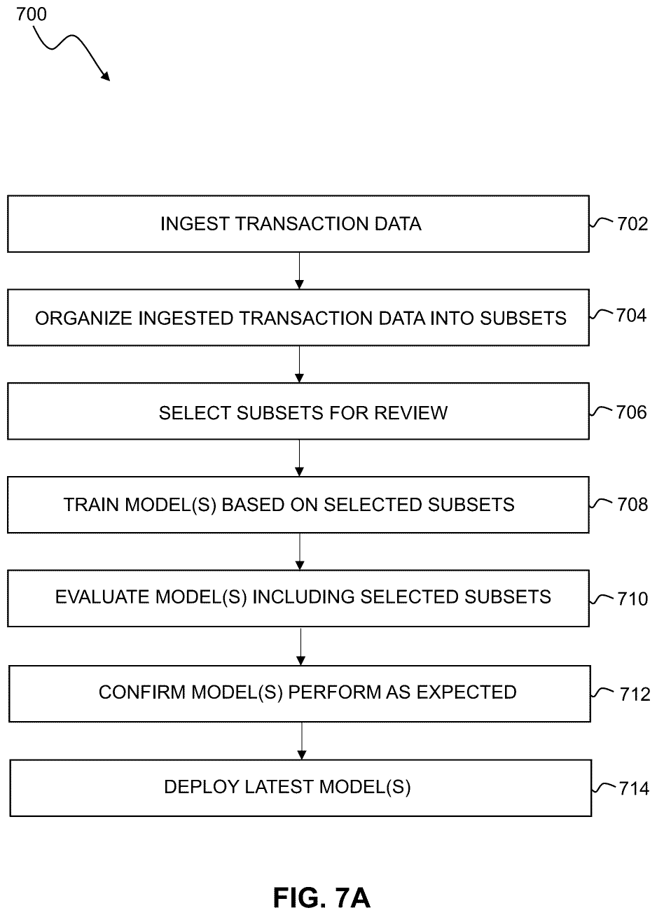

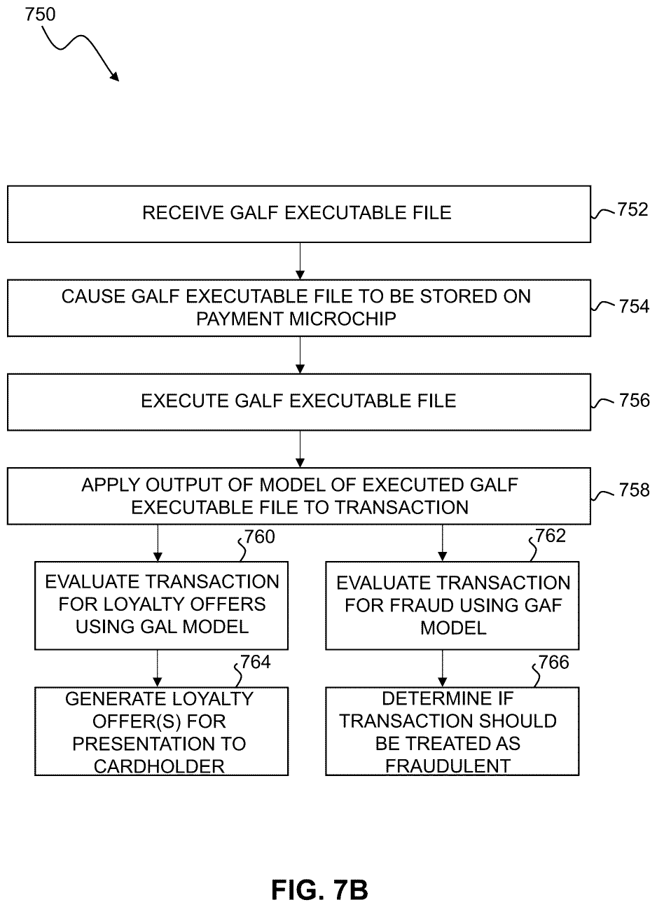

FIGS. 7A and 7B illustrate example methods according to embodiments of the present disclosure. FIG. 7A illustrates an example method 700 for creating the GAL and GAF models described herein, such as in connection with FIG. 6. Method 700 includes ingesting 702 transaction data. Such data may include but is not limited to purchase amount, merchant, date/time, POS terminal type, loyalty points awarded/redeemed, and/or any fraud aspects (e.g., purchase fits within cardholder's normal pattern, or falls outside of established patterns). Method 700 also includes organizing 704 the ingested transaction data into subsets. This may include referencing and/or utilizing rules such as rules 560 and tables such as tables 562 (each shown in FIG. 5B). For example, loyalty rules may be used to organize loyalty information into loyalty tables and fraud rules may be used to organize fraud information into fraud tables. Such tables may be able to be queried and data therein referenced and/or extracted therefrom for other purposes, such as training purposes. Method 700 further includes selecting 706 subsets of data for review, for example as described in connection with subsets 612 and 636 shown in and described in connection with FIG. 6. Method 700 further includes training 708 the GAL and GAF models based on the selected subsets, using the ML and other techniques as described herein. Method 700 further includes evaluating 710 the GAL and GAF models that include the selected subsets. Method 700 further includes confirming 712 the GAL and GAF models perform as expected. This may involve human review. If the models do not perform as expected, modifications may be made to the parameters of the models. For example, certain weights may be adjusted, and then the models would again be evaluated for accuracy. This may also include comparisons to other models. Method 700 yet further includes deploying 714 a latest version of each of the GAL and GAF models once the models have been confirmed to produce accurate results.

FIG. 7B illustrates an example method 750 for utilizing the systems and methods described herein during a transaction using a payment card according to one embodiment of the present disclosure. Method 750 includes receiving 752 a GALF executable file, such as GALF executable file 658 shown in FIG. 6, received via network 206. The GALF executable file may include the GAL and GAF models packaged in a format suitable for download and/or use by both POS terminal 402 and/or payment microchip 422. POS terminal 402 may power payment microchip 422 so that the latest GALF models are downloaded from a database/server associated with GALF computing system 120 as described herein, for deposition onto payment microchip 422. Method 750 also includes causing 754 the GALF executable file to be stored on payment microchip 422. With reference to FIG. 5A, this may include data transfer via NFC protocols. Method 750 further includes executing 756 the GALF executable file. Method 750 further includes applying 758 an output of one or more models of the GALF executable file to the current transaction. This may include applying an output of the latest updated model such as trained GAL model 616 and/or trained GAF model 640 to the transaction. Method 750 may include evaluating 760, 762 various transaction data and parameters in accordance with trained models 616 and/or 640. For example, the type of items being purchased may be evaluated 760 by a trained GAL model such as model 616 to determine any applicable loyalty offers are available. In some scenarios it may be determined that the purchase only qualifies for standard loyalty points earning rates, while in other scenarios, such as where a limited time promotion is running, it may be determined that the purchase qualifies for earning elevated or bonus loyalty points (e.g., “earn 3× points on purchase on a new lawn mower”). Method 750 further includes generating 764 cardholder offers such as loyalty offers for presentation to customers if there are any applicable loyalty point offers and/or other incentives available, for presentation to the customer via display screen 404 of POS terminal 402, such as shown in FIG. 4. At the same time, the purchase may be evaluated 762 by the latest GAF model such as trained GAF model 640 to make determinations as to whether there are any fraud concerns. Transaction information including but not limited to the type of items being purchased, the amount of items being purchased, the time and location of the items being purchased, and various other factors may be evaluated 762 by a trained GAF model such as model 640 to determine if the transaction is fraudulent. In some scenarios this may be determined by comparing such transaction information to one or more fraud rules associated with the cardholder. These fraud rules may include personalized fraud rules such as learned/generated by the GAF model and/or more generic fraud rules defined by the various entities shown in FIGS. 2 and/or 3. For example, a more generic fraud rule may include a frequency/velocity rule, where if a plurality of transactions are detected in a very short span of time, a fraud flag may be set (e.g., regardless of other rules such as more personalized rules). Method 750 further includes determining 766 if the transaction should be treated as fraudulent based on the results of the fraud comparison. For example, the GAF model may learn that the cardholder only ever shops between 8:00 am to 10:00 am, Any purchases outside of that time frame may be treated as potentially fraudulent and then scrutinized in conjunction with other user data and/or rules to make a fraud determination.

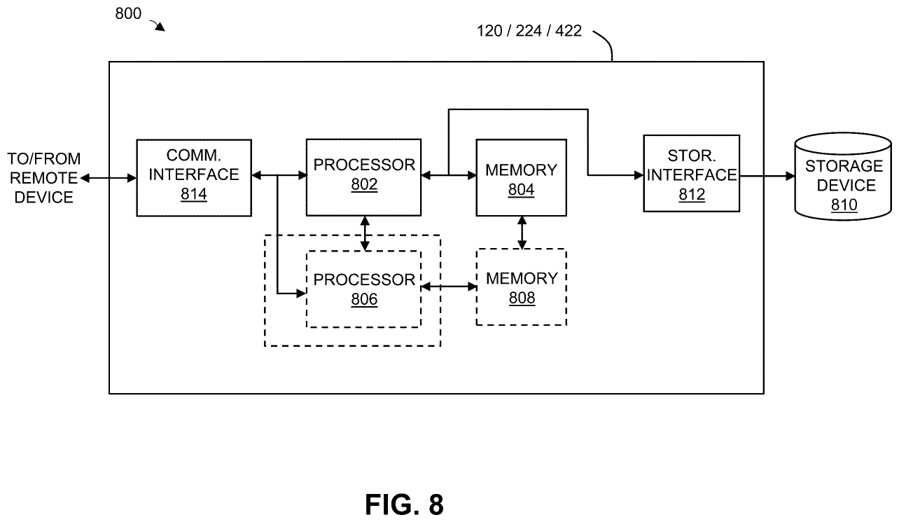

FIG. 8 illustrates an example configuration 800 of a computing system such as GALF computing system 120 and/or additional computing system 224 in accordance with one example embodiment of the present disclosure. Configuration 800 may include a processor 802 operatively coupled with a memory 804. In some embodiments, configuration 800 may include one or more additional processors 806 operatively coupled with one or more additional memories 808, where the processors 802, 806 and memories 804, 808 may be operatively coupled with one another, and may be configured to provide distributed and/or parallel computing functions (e.g., to assist with resource heavy computing tasks). In some aspects, additional processors 806 and additional memories 808 may be integrated with GALF computing system 120, or may be integrated with one or more other (e.g., external) computing systems that is/are operatively coupled with GALF computing system 120, such as additional computing system 224. Additionally, or alternatively, payment microchip 422 may be configured with dedicated processors to run each of a GAL model and a GAF model at a point of purchase (e.g., on the edge of the network). Such parallel processing power on payment microchip 422 may increase the speed and efficiency of making determinations using the models for any given purchase. Configuration 800 may also include a storage device 810 configured to store data, and be accessible via storage interface 812. While storage device 810 is shown in FIG. 8 as being external to configuration 800, storage device 810 may be integrated with configuration 800. Storage device 810 may be embodied as storage system 220 shown in FIG. 2 (or vice versa, where storage system 220 may have a storage interface that is the same as or similar to storage interface 812)), or other storage devices within subsystem 200. Configuration 800 may communicate (e.g., via network 206) with other devices (e.g., remote devices) within subsystem 200 as shown in FIG. 2 via a communication interface 814.

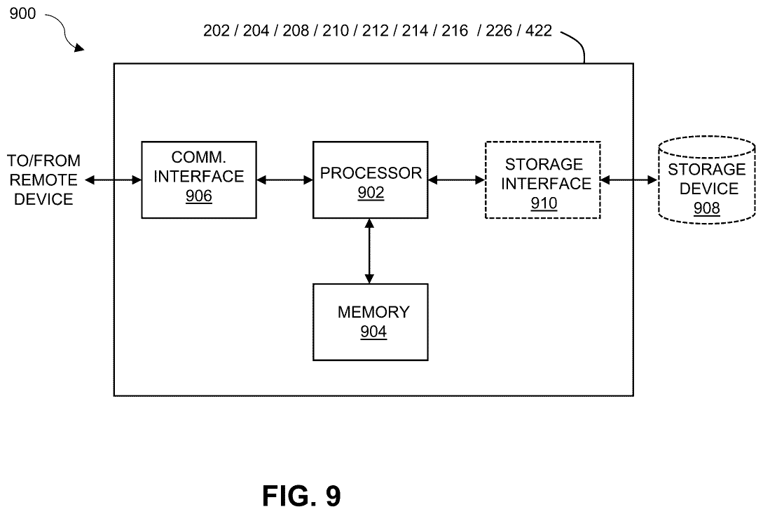

FIG. 9 illustrates an example configuration 900 of client computing devices and/or servers such as the various client computing devices (e.g., 202, 204, 224), databases (e.g., 212), and/or server devices (e.g., 208, 210, 214, 216, 226, 230) in accordance with one example embodiment of the present disclosure. Configuration 900 includes a processor 902 operatively coupled with a memory 904. The various devices (e.g., 202, 204, etc., and/or 208, 210, etc.) may communicate with other devices (e.g., remote devices) within subsystem 200 shown in FIG. 2 via a communication interface 906 operatively coupled to processor 902. In some embodiments, processor 902 is operatively coupled to storage device 908 via a storage interface 910, to access or store data within storage device 908. Storage device 908 may be standalone storage or embodied as any storage device within subsystem 200 as described herein.

In some embodiments, payment microchip 422 may be configured as either of configuration 800 or 900. Payment microchip 422 may be configured to perform tasks using its own processing power such as provided via controller 520, and/or to leverage external processing power such as parallel and/or distributed processing by way of external processors such as processors 802, 806, and/or 902. For example, in a scenario where payment card 420 is inserted into POS terminal 402, processing power of POS terminal 402 may be leveraged in association with controller 520 to assist with running the GAL and/or GAF models on payment microchip 422 to process and analyze a given transaction for loyalty and/or fraud purposes. This may be performed in an edge computing manner as described herein. In doing so, transactions can be analyzed dynamically and in real-time with no inconvenience and/or delay introduced into the transaction. Such parallel/distributed computing power is, however, not required and only represents an option to achieve the stated results.

FIG. 10 illustrates an example configuration 1000 of a user device such as transaction processing device 112 (e.g., which may be embodied as POS terminal 402), and/or computing device 222 used in conjunction with GALF computing system 120, such as within subsystem 200. Configuration 1000 includes a processor 1004 operatively coupled with a memory 1006. Configuration 1000 may also include at least one media output component 1008 for presenting information to user 1002. In some embodiments, media output component 1008 includes an output adapter such as a video adapter and/or an audio adapter. An output adapter is operatively coupled to processor 1004 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, user computing device 222 includes an input device 1010 for receiving input from user 1002. Input device 1010 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1008 and input device 1010. Configuration 1000 may include a server (not shown) configured to provide access to resources, data, services, and/or programs to other computers. Configuration 1000 further includes a communication interface 1012 so that user computing device 222 may communicate with other computing devices (e.g., remote devices) within subsystem 200 shown in FIG. 2.

In some embodiments, user computing device 222 may be a smartphone of cardholder 102, where user 1002 is cardholder 102 and computing device 222 is used by cardholder 102 to make transactions. In other embodiments, user computing device 222 may be a computing device of an entity that provides, owns and/or operates GALF computing system 120, where user 1002 may be an employee of the entity, for example. In such an embodiment, user 1002 may review outputs from GALF computing system 120, such as outputs 628 and 650 from model modules 606 and 630 shown in FIG. 6, respectively. These outputs may be output in a user-readable format for presentation to the user 1002, so that the user 1002 may analyze the results (e.g., for purposes of verifying the accuracy of the loyalty and/or fraud predictions and/or outputs 628 and 650 from model modules 606 and 630), for purposes of updating, evaluating, and/or refining the models. In yet further embodiments, transaction processing device 112 may be configured in a manner the same as or similar to configuration 1000, where user 1002 may be the same as or similar to cardholder 102 (e.g., in an in-store scenario, user 1002 is an in-store customer using transaction processing device 112 to make an in-store purchase).

Each of the processors (e.g., 802, 806, 902, 1004) described in connection with FIGS. 8-10 may be configured to execute instructions that may be stored in the corresponding memories (e.g., 804, 808, 904, 1006) shown in and described in connection with FIGS. 8-10, for example. The processors may include one or more processing units (e.g., in a multi-core configuration) for executing instructions, and may be configured to operate in a parallel processing environment as described herein. The instructions may be executed within a variety of different operating systems on the respective systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). The memories may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Each of the storage devices (e.g., 810, 908) shown in and described in connection with FIGS. 8 and 9 may include one or more computer-readable media, such as one or more hard disk drives or solid state disks in a redundant array of inexpensive disks (RAID) configuration, and further may include a storage area network (SAN) and/or a network attached storage (NAS) system. Each of the storage interfaces (e.g., 812, 910) shown in and described in connection with FIGS. 8 and 9 may be any component capable of providing the processors with access to the storage devices. Storage interfaces may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processors with access to the storage devices.

Each of the various communication interfaces (e.g., 814, 906, 1012) shown in and described in connection with FIGS. 8-10 may be communicatively couplable to a remote device such as a server system (e.g., 208, 210, 214, 216, etc.) or a web server, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). For example, communication interface 814 may receive data from payment network server 208 and/or issuer computing system 204 via the Internet, as illustrated in FIG. 2.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The non-transitory computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals. Unless otherwise specified, a module as referred to herein is a software module including specialized code for a particular task.

The above-described embodiments of a method and system of computing velocities in an efficient manner within a distributed computing systems framework provides a cost-effective and time-saving means for analyzing a high volume of transaction data in payment network platforms. As a result, the methods and systems described herein facilitate leveraging a payment network's assets to improve analysis of data contained within the network, to thereby improve the quality of data within the network.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An intelligent microchip payment card of a cardholder for providing secure and personalized payment transactions processed over a payment network using generative artificial intelligence tools, the intelligent payment microchip card comprising:
at least one memory device for storing a generative artificial intelligence (Gen AI) loyalty and fraud model; and
at least one processor in communication with the at least one memory device, the at least one processor programmed to:
initiate a payment transaction by communicating with a point-of-sale (POS) terminal of a merchant;
receive payment transaction data associated with the payment transaction;
execute the Gen AI loyalty and fraud model by inputting the payment transaction data into the Gen AI loyalty and fraud model stored at the at least one memory device of the intelligent payment microchip card;
output one or more fraud determinations from the Gen AI loyalty and fraud model relating to the payment transaction data; and
cause the payment transaction to be approved or denied based on the one or more fraud determinations without centralized processing of the payment transaction data for fraud being performed at the network-level by the payment network processing the payment transaction.

2. An intelligent microchip payment card in accordance with claim 1, wherein the at least one processor is further programmed to:
output one or more loyalty determinations from the Gen AI loyalty and fraud model relating to the payment transaction data; and
apply the one or more loyalty determinations to the payment transaction.

3. An intelligent microchip payment card in accordance with claim 2, wherein the at least one processor is further programmed to:
cause the Gen AI fraud and loyalty model to be updated based on each of the one or more fraud determinations and the one or more loyalty determinations.

4. An intelligent microchip payment card in accordance with claim 2, wherein the at least one processor is further programmed to:
determine each of the one or more fraud determinations and the one or more loyalty determinations based on information stored in a cardholder profile of the cardholder.

5. An intelligent microchip payment card in accordance with claim 2, wherein the one or more loyalty determinations being applied to the payment transaction includes at least one of: (i) presenting the cardholder with one or more discount offers relating to the payment transaction; (ii) tracking loyalty points associated with the payment transaction; (iii) providing the cardholder with an option to apply loyalty points to the payment transaction; and (iv) awarding loyalty points for the payment transaction.

6. An intelligent microchip payment card in accordance with claim 5, wherein each of (i) the presenting the cardholder with one or more discount offers relating to the payment transaction; (ii) the tracking loyalty points associated with the payment transaction; (iii) the providing the cardholder with an option to apply loyalty points to the payment transaction; and (iv) the awarding loyalty points for the payment transaction is based at least on personalized analysis by the Gen AI fraud and loyalty model of historical transaction patterns of the cardholder.

7. An intelligent microchip payment card in accordance with claim 5, wherein the one or more discount offers include at least one of a discount offer relating to the payment transaction and a loyalty points incentive relating to the payment transaction.

8. A computer-implemented method for providing secure and personalized payment transactions processed over a payment network using an intelligent microchip payment card with generative artificial intelligence tools, the method comprising:
storing on at least one memory of the intelligent microchip payment card a generative artificial intelligence (Gen AI) loyalty and fraud model;
initiating, via the intelligent microchip payment card, a payment transaction by communicating with a point-of-sale (POS) terminal of a merchant;
receiving payment transaction data associated with the payment transaction at the intelligent microchip payment card;
executing the Gen AI loyalty and fraud model by inputting the payment transaction data into the Gen AI loyalty and fraud model;
outputting one or more fraud determinations from the Gen AI loyalty and fraud model relating to the payment transaction data; and
causing the payment transaction to be approved or denied based on the one or more fraud determinations without centralized processing of the payment transaction data for fraud being performed at the network-level by the payment network processing the payment transaction.

9. A method in accordance with claim 8, further comprising:
outputting one or more loyalty determinations from the Gen AI loyalty and fraud model relating to the payment transaction data; and
applying the one or more loyalty determinations to the payment transaction.

10. A method in accordance with claim 9, further comprising causing the Gen AI fraud and loyalty model to be updated based on each of the one or more fraud determinations and the one or more loyalty determinations.

11. A method in accordance with claim 9, further comprising determining each of the one or more fraud determinations and the one or more loyalty determinations based on information stored in a cardholder profile of a cardholder associated with the intelligent payment microchip card.

12. One or more non-transitory computer-readable storage media with instructions stored thereon that, in response to being executed, cause an intelligent microchip payment card for providing secure and personalized transactions processed over a payment network using generative artificial intelligence tools to:
store, in at least one memory of the intelligent microchip payment card, a generative artificial intelligence (Gen AI) loyalty and fraud model;
initiate a payment transaction by communicating with a point-of-sale (POS) terminal of a merchant;
receive payment transaction data associated with the payment transaction;
execute the Gen AI loyalty and fraud model by inputting the payment transaction data into the Gen AI loyalty and fraud model stored at the at least one memory of the intelligent microchip payment card;
output one or more fraud determinations from the Gen AI loyalty and fraud model relating to the payment transaction data; and
cause the payment transaction to be approved or denied based on the one or more fraud determinations without centralized processing of the payment transaction data for fraud being performed at the network-level by the payment network processing the payment transaction.

13. One or more non-transitory computer-readable storage media in accordance with claim 12, wherein the instructions, in response to being executed, further cause the intelligent microchip payment card to:
output one or more loyalty determinations from the Gen AI loyalty and fraud model relating to the payment transaction data; and
apply the one or more loyalty determinations to the payment transaction.

14. One or more non-transitory computer-readable storage media in accordance with claim 13, wherein the instructions, in response to being executed, further cause the intelligent microchip payment card to:
cause the Gen AI fraud and loyalty model to be updated based on each of the one or more fraud determinations and the one or more loyalty determinations.

15. One or more non-transitory computer-readable storage media in accordance with claim 13, wherein the instructions, in response to being executed, further cause the intelligent microchip payment card to:
determine each of the one or more fraud determinations and the one or more loyalty determinations based on information stored in a cardholder profile of a cardholder associated with the intelligent microchip payment card.

16. A computer-based payment system for providing secure and personalized transactions processed over a payment network using generative artificial intelligence tools, the computer-based payment system comprising:
an intelligent microchip payment card associated with a cardholder, the intelligent microchip payment card comprising a microchip and memory storing a generative artificial intelligence (Gen AI) loyalty and fraud model; and
a point-of-sale (POS) terminal configured to interface with the intelligent microchip payment card, the POS terminal including:
at least one POS terminal memory device for storing POS terminal data; and
at least one POS terminal processor in communication with the at least one POS terminal memory device, the at least one POS terminal processor programmed to:
initiate a payment transaction by communicating with the intelligent microchip payment card and providing payment transaction data to the microchip;
wherein the microchip is configured to:
receive the payment transaction data;
execute the Gen AI loyalty and fraud model by inputting the payment transaction data into the Gen AI loyalty and fraud model stored at the memory of the intelligent microchip payment card;
output one or more fraud determinations from the Gen AI loyalty and fraud model relating to the payment transaction data; and
cause the payment transaction to be approved or denied based on the one or more fraud determinations without centralized processing of the payment transaction data for fraud being performed at the network-level by the payment network processing the payment transaction.

17. A computer-based payment system in accordance with claim 16, further comprising a Gen AI loyalty and fraud (GALF) computing system, the GALF computing system including:
at least one GALF computing system memory device for storing GALF computing system data; and
at least one GALF computing system processor in communication with the at least one GALF computing system memory device, the at least one GALF computing system processor programmed to:
receive historical transaction data of the cardholder from historical transactions of the cardholder made at one or more merchants;
process the historical transaction data to generate a plurality of loyalty and fraud parameters of the cardholder;
train and update the Gen AI loyalty and fraud model based on the plurality of loyalty and fraud parameters of the cardholder; and
output the Gen AI loyalty and fraud model for storage and use on the microchip.

18. A computer-based payment system in accordance with claim 16, wherein the POS terminal and the intelligent microchip payment card are configured in an edge computing arrangement.

19. A computer-based payment system in accordance with claim 16, wherein the one or more loyalty determinations are based on a comparison of parameters of the payment transaction to information contained in a cardholder profile of the cardholder.

20. A computer-based payment system in accordance with claim 19, wherein the at least one POS terminal processor is further programmed to:
present, to the cardholder, via a display screen of the POS terminal, at least one of: (i) at least one discount offer relating to the payment transaction and (ii) at least one incentive relating to the payment transaction, the at least one discount offer corresponding to cardholder offer information stored in the cardholder profile, and the at least one incentive corresponding to cardholder incentive information stored in the cardholder profile.
